(19) United States
(12) Patent Application Publication
(10) Pub. No.: US 2020/0373666 A1
(43) Pub. Date: Nov. 26, 2020

(54) MULTIBAND ANTENNA, WIRELESS COMMUNICATION MODULE, AND WIRELESS COMMUNICATION DEVICE

(71) Applicant: HITACHI METALS, LTD., Minato-ku, Tokyo (JP)

(72) Inventors: Yasunori TAKAKI, Minato-ku, Tokyo (JP); Kenji HAYASHI, Minato-ku, Tokyo (JP)

(21) Appl. No.: 16/967,798

(22) PCT Filed: Feb. 12, 2019
(86) PCT No.: PCT/JP2019/004890

§ 371 Date: Aug. 6, 2020

(30) Foreign Application Priority Data
Feb. 14, 2018 (JP) 2018-024103

(51) Int. Cl. H01Q 5/307; H01Q 13/10; H01Q 1/48

(52) U.S. Cl. CPC H01Q 5/307; H01Q 1/48; H01Q 13/106

(57) ABSTRACT

A multiband antenna includes: a radiating conductor including a rectangular-shaped first slit extending along a second axis direction of a first right-hand orthogonal coordinate system having a first axis direction, the second axis direction, and a third axis direction; a ground conductor which is spaced apart from the radiating conductor by a predetermined interval along the third axis direction; and a first strip conductor being positioned between the radiating conductor and the ground conductor, and extending along the first axis direction. An end portion of the first strip conductor overlaps the first slit when viewed along the third axis direction.

### TECHNICAL FIELD

The present application relates to a multiband antenna, a wireless communication module, and a wireless communication apparatus.

### BACKGROUND ART

With increasing amounts of Internet communications, and with the developments of video technology with high image quality, increased speed of communication is required of wireless communications, and there is a desire for high-frequency wireless communication techniques which enable transmission/reception of greater amounts of information.

Moreover, different countries and different regions often permit wireless communications in different frequency bands, and in order to reduce costs associated with wireless communication devices, wireless communication devices that support a plurality of frequency bands are being desired. Alternatively, wireless communication devices which can transmit greater amounts of information by simultaneously using radio waves of different frequency bands are being desired.

In such wireless communication devices, a multiband antenna that is capable of transmission/reception of radio waves in a plurality of different frequency bands is used. For example, Patent Document 1 discloses a multiband antenna that can be downsized without compromising antenna performance.

### CITATION LIST

### Patent Literature

Patent Document 1: Japanese Patent Publication No. 2015-062276

### SUMMARY OF INVENTION

### Technical Problem

The present application provides a multiband antenna, a wireless communication module, and a wireless communication apparatus which are capable of transmission/reception in a plurality of frequency bands, namely, quasi-microwave, centimeter wave, quasi-millimeter wave, and millimeter wave bands.

### Solution to Problem

A multiband antenna according to the present disclosure comprises:

a radiating conductor including a rectangular-shaped first slit extending along a second axis direction of a first right-hand orthogonal coordinate system having a first axis direction, the second axis direction, and a third axis direction;

a ground conductor which is spaced apart from the radiating conductor by a predetermined interval along the third axis direction; and

a first strip conductor being positioned between the radiating conductor and the ground conductor, and extending along the first axis direction, wherein

an end portion of the first strip conductor overlaps the first slit, when viewed along the third axis direction.

An end portion of the first strip conductor may overlap a neighborhood of a center of the first slit when viewed along the third axis direction.

The radiating conductor may include a first region and a second region which are separated by a border line extending along the second axis direction at a center of the first axis direction; and

when viewed along the third axis direction, the first strip conductor may overlap the first region of the radiating conductor but not overlap the second region.

The radiating conductor may further include a rectangular-shaped second slit extending along the first axis direction.

In the radiating conductor, the second slit may be spaced apart from the first slit.

In the radiating conductor, the second slit may cross or connect to the first slit.

In the radiating conductor, the first slit and the second slit may be positioned axisymmetric to each other with respect to a line which passes through an origin of the first right-hand orthogonal coordinate system and which makes an angle of 45° with the first axis when viewed along the third axis direction.

A second strip conductor being positioned between the radiating conductor and the ground conductor and extending along the second axis direction may be comprised; and

when viewed along the third axis direction, an end portion of the second strip conductor may overlap the second slit but not overlap the first slit.

Opposite ends of the first strip conductor may be located at different heights along the third axis direction.

The multiband antenna may further comprise at least one unpowered radiating conductor positioned adjacent to at least one of a pair of sides of the radiating conductor, the pair of sides being located in the first axis direction or in the second axis direction.

The multiband antenna may further comprise an unpowered radiating conductor which surrounds the radiating conductor and which is spaced apart the radiating conductor when viewed along the third axis direction.

The multiband antenna may further comprise one or more linear radiating conductors being spaced apart from the radiating conductor along the first axis direction and extending along the second axis direction, wherein,

the radiating conductor, the first strip conductor, and the ground conductor may constitute a planar antenna; and

the linear radiating conductor may constitute a linear antenna.

The linear radiating conductor may not overlap the ground conductor when viewed along the third axis direction.

The multiband antenna may further comprise a dielectric having a principal face perpendicular to the third axis direction, wherein at least the ground conductor and the first strip conductor are located within the dielectric.

The multiband antenna may further comprise a dielectric having a principal face perpendicular to the third axis direction and a side face which is adjacent to the principal face and which is perpendicular to the first axis direction, wherein,

at least the ground conductor and the first strip conductor may be located within the dielectric; and

the linear radiating conductor of the linear antenna may be located close to the side face.

The planar antenna and the linear radiating conductor may be located on the principal face.

The dielectric may be a multilayer ceramic body.

The radiating conductor may have a shape obtained by truncating a pair of corners of a rectangle having four corners, the pair of corners being located along a diagonal direction.

A multiband array antenna according to the present disclosure comprises a plurality of any of the above multiband antennas, wherein,

the plurality of multiband antennas are arranged along the second axis direction; and

the ground conductors of the plurality of multiband antennas are connected together along the second axis direction.

A wireless communication module according to the present disclosure comprises the above multiband array antenna.

A wireless communication apparatus according to the present disclosure comprises:

a circuit board including, based on a second right-hand orthogonal coordinate system having a first axis direction, a second axis direction, and a third axis direction: a first principal face and a second principal face perpendicular to the third axis direction; a first side face and a second side face perpendicular to the first axis direction; and a third side face and a fourth side face perpendicular to the second axis direction, the circuit board including at least one of a transmission circuit and a reception circuit; and

at least one said wireless communication module, wherein,

the wireless communication module is positioned on any of the first side face, the second side face, the third side face, and the fourth side face.

Another wireless communication apparatus according to the present disclosure comprises:

a circuit board including, based on a second right-hand orthogonal coordinate system having a first axis direction, a second axis direction, and a third axis direction: a first principal face and a second principal face perpendicular to the third axis direction; a first side face and a second side face perpendicular to the first axis direction; and a third side face and a fourth side face perpendicular to the second axis direction, the circuit board including at least one of a transmission circuit and a reception circuit; and

at least one said wireless communication module, wherein,

the wireless communication module is positioned in any of: a portion of the first principal face near the first side face; a portion of the first principal face near the third side face; a portion of the second principal face near the third side face; and a portion of the second principal face near the fourth side face.

### Advantageous Effects of Invention

According to the present disclosure, it is possible to realize a multiband antenna, a wireless communication module, and a wireless communication apparatus which are capable of transmission/reception in a plurality of frequency bands, namely, quasi-microwave, centimeter wave, quasi-millimeter wave, and millimeter wave bands.

### BRIEF DESCRIPTION OF DRAWINGS

FIG. 1 (a) is a plan view showing a multiband antenna according to a first embodiment of the present disclosure; and (b) is a cross-sectional view of the multiband antenna shown in (a) along line 1B-1B.

FIG. 2 An exploded perspective view of the multiband antenna shown in FIG. 1.

FIG. 3 A schematic diagram showing paths of electromagnetic waves in the multiband antenna shown in FIG. 1.

FIG. 4 (a) shows an example of frequency characteristics of return loss of the multiband antenna shown in FIG. 1 as determined through a simulation; and (b) shows an example of frequency characteristics of return loss of an antenna for comparison.

FIG. 5 (a) is a plan view showing a multiband antenna according to a second embodiment of the present disclosure; and (b) is a cross-sectional view of the multiband antenna shown in (a) along line 5B-5B.

FIG. 6 (a) is a schematic diagram showing paths of electromagnetic waves in the multiband antenna shown in FIG. 5; and (b) through (d) are diagrams showing another exemplary positioning of a second slit provided in a radiating conductor.

FIG. 7 Shows an example of frequency characteristics of return loss of the multiband antenna shown in FIG. 5 as determined through a simulation.

FIG. 8 (a) is a plan view showing a multiband antenna according to a third embodiment of the present disclosure; and (b) is a cross-sectional view of the multiband antenna shown in (a) along line 1B-1B.

FIG. 9 Shows an example of frequency characteristics of return loss of the multiband antenna shown in FIG. 8 as determined through a simulation.

FIG. 10 (a) is a plan view showing another example of a multiband antenna according to the third embodiment of the present disclosure; and (b) is a cross-sectional view of the multiband antenna shown in (a) along line 10B-10B.

FIG. 11 (a) is a perspective view showing a multiband antenna according to a fourth embodiment of the present disclosure; and (b) is a cross-sectional view of the multiband antenna shown in (a) along line 11B-11B. (c) and (d) show exemplary structures in the case where the linear antenna is employed for multiband uses.

FIG. 12 A perspective view showing a fifth embodiment of a multiband antenna according to the present disclosure.

FIG. 13 A perspective view showing another example of a multiband antenna according to the fifth embodiment of the present disclosure.

FIG. 14 A perspective view showing an embodiment of an array antenna according to the present disclosure.

FIG. 15 A diagram showing an electromagnetic wave to be radiated from the array antenna shown in FIG. 14.

FIG. 16 A diagram showing an electromagnetic wave to be radiated from the array antenna shown in FIG. 14.

FIG. 17 (a) and (b) are diagram showings other shapes for ground conductors in the array antenna shown in FIG. 14.

FIG. 18 A schematic cross-sectional view showing an embodiment of a wireless communication module according to the present disclosure.

FIG. 19 (a) and (b) are a schematic plan view and a side view of an embodiment of a wireless communication apparatus according to the present disclosure.

FIG. 20 (a), (b), and (c) are a schematic plan view and side views showing another implementation of a wireless communication apparatus according to the present disclosure.

FIG. 21 (a) and (b) show gain distributions of the wireless communication apparatus show in FIG. 20 as determined through a simulation.

FIG. 22 (a) is a plan view showing another implementation of a multiband antenna according to the present disclosure; and (b) is a cross-sectional view along line 22B-22B.

FIG. 23 (a) is a plan view showing another implementation of a multiband antenna according to the present disclosure; and (b) is a cross-sectional view along line 23B-23B.

FIG. 24 (a) is a plan view showing another implementation of a multiband antenna according to the present disclosure; and (b) is a cross-sectional view along line 24B-24B.

FIG. 25 (a) is a plan view showing another implementation of a multiband antenna according to the present disclosure; and (b) is a cross-sectional view along line 25B-25B.

FIG. 26 (a) is a plan view showing another implementation of a multiband antenna according to the present disclosure; and (b) is a cross-sectional view along line 26B-26B.

FIG. 27 A schematic cross-sectional view showing another implementation of the wireless communication module.

FIG. 28 A schematic cross-sectional view showing another implementation of the wireless communication module.

### DESCRIPTION OF EMBODIMENTS

A multiband antenna, a wireless communication module, and a wireless communication apparatus according to the present disclosure are applicable to wireless communications in the quasi-microwave, centimeter wave, quasi-millimeter wave, and millimeter wave bands, for example. Wireless communications in the quasi-microwave band utilize radio waves having a wavelength of 10 cm to 30 cm and a frequency from 1 GHz to 3 GHz as the carrier wave. Wireless communications in the centimeter wave band utilize radio waves having a wavelength of 1 cm to 10 cm and a frequency of 3 GHz to 30 GHz as the carrier wave. Wireless communications in the millimeter wave band utilize radio waves having a wavelength of 1 mm to 10 mm and a frequency of 30 GHz to 300 GHz as the carrier wave. Wireless communications of the quasi-millimeter wave band utilize radio waves having a wavelength of 10 mm to 30 mm and a frequency of 10 GHz to 30 GHz as the carrier wave. In wireless communications of these bands, linear antennas and planar antennas will be sized on the order of several centimeters to submillimeters. For example, in the case where a quasi-microwave, centimeter wave, quasi-millimeter wave, and millimeter wave bands wireless communication circuit is composed of a sintered multilayer ceramic substrate, a multiaxial antenna according to the present disclosure can be mounted on the sintered multilayer ceramic substrate. Hereinafter, unless otherwise specified, the present embodiment will illustrate the multiband antenna with respect to the case where the carrier wave has a frequency of 30 GHz and the carrier wave has a wavelength λ of 10 mm, this being an example of a carrier wave which is a quasi-microwave, centimeter wave, quasi-millimeter wave, and millimeter wave bands.

In the present disclosure, right-hand orthogonal coordinate systems will be employed in explaining the positioning, directions, etc., of component elements. Specifically, a first right-hand orthogonal coordinate system includes x, y, and z axes which are orthogonal to one another, and a second right-hand orthogonal coordinate system includes u, v, and w axes which are orthogonal to one another. Although the alphabetical letters x, y, z, and u, v, w are assigned to the axes in order to distinguish between the first right-hand orthogonal coordinate system and the second right-hand orthogonal coordinate system and to identify the order of right-handed coordinate axes, these may well be referred to as first, second, and third axes.

In the present disclosure, two directions being aligned means that an angle made by the two directions is generally in the range of 0° to about 45°. Being parallel means that an angle made by two planes, two lines, or a plane and a line is in the range from 0° to about 10°. In describing a direction with reference to an axis, +/− on the axis will be differentiated when it is important whether something is in the + direction or the − direction from a reference on that axis. On the other hand, when importance lies in which axis a direction is along, with no distinction between the + direction and the − direction on the axis, it will simply be referred to as the “axis direction”.

### First Embodiment

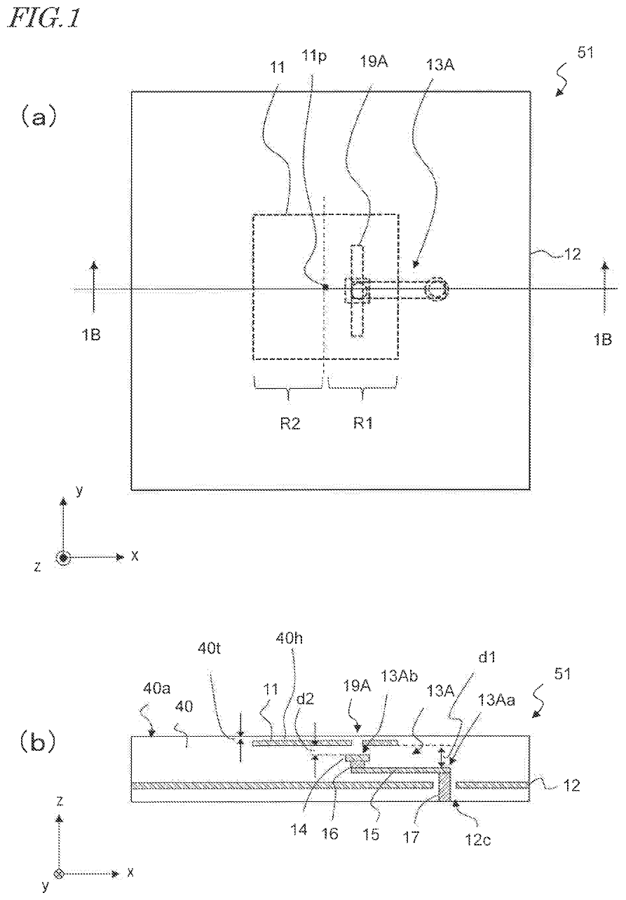

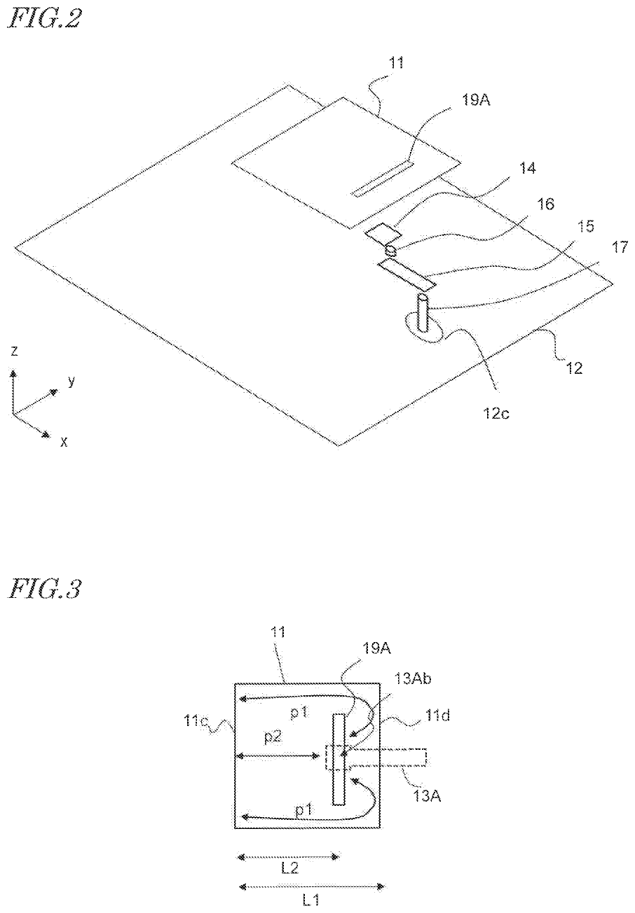

A first embodiment of a multiband antenna according to the present disclosure will be described. FIG. 1(a) is a schematic top view showing a multiband antenna 51 according to the present disclosure. FIG. 1(b) is a schematic cross-sectional view of the multiband antenna 51 along line 1B-1B in FIG. 1(a). FIG. 2 is an exploded perspective view of the multiband antenna 51.

The multiband antenna 51 is a planar antenna, and is also called a patch antenna. The multiband antenna 51 includes a radiating conductor 11, a ground conductor 12, and a first strip conductor 13A. As will be described later, the multiband antenna 51 further includes a dielectric 40, such that the radiating conductor 11, the ground conductor 12, and the first strip conductor 13A are provided within the dielectric 40. In FIG. 2, the dielectric 40 is omitted.

The radiating conductor 11 is a radiating element which radiates radio waves. For example, in the present embodiment, the radiating conductor 11 has a rectangle (square) shape. However, the radiating conductor 11 may have a circular shape or any other shape. The radiating conductor 11 has a rectangular-shaped first slit 19A, which extends along the y axis (second axis) direction. Preferably, in plan view, i.e., as viewed along a z axis direction perpendicular to the xy plane, the first slit 19A is located between the center of the radiating conductor 11 and one of the four sides of the rectangle. In other words, the radiating conductor 11 includes a first region R1 and a second region R2 which are split by a border line extending along the y axis direction at a center 11p of the x axis direction of the radiating conductor 11, such that, as viewed along the z axis direction, the first strip conductor 13A overlaps the first region R1, but does not overlap the second region R2. The size of the radiating conductor 11 may be 0.5 to 2.5 mm×0.5 to 2.5 mm, when assuming the 28 GHz band, for example. The shape of the radiating conductor 11 may be a square, or a rectangle at least whose length along a direction that is parallel to the first strip conductor 13A is set to a length that causes resonation at f0.

The first slit 19A is a throughhole being made in the radiating conductor 11 and extending along the y axis (second axis) direction. The size of the first slit 19A may be, for example, 0.2 to 1.9 mm×0.01 to 1 mm, so that its length along the x axis direction is shorter than its length along the y axis direction. In FIG. 1, for example, the radiating conductor 11 may be 1.5 mm×1.5 mm, and the first slit 19A may be 1.185 mm×0.1 mm.

The ground conductor 12 is a ground electrode to be connected to a reference potential. The ground conductor 12 is positioned so as to be spaced apart from the radiating conductor 11 by a predetermined distance along the z axis direction. As viewed along the z axis direction, the ground conductor 12 is located in a region which is larger than the radiating conductor 11 and which at least contains a region under the radiating conductor 11.

The first strip conductor 13A has electromagnetic field coupling with the radiating conductor 11, and supplies signal power to the radiating conductor 11. The first strip conductor 13A is located between the radiating conductor 11 and the ground conductor 12, and extends along the x axis direction, such that a part or a whole thereof as viewed along the z axis direction overlaps the radiating conductor 11.

In the present embodiment, the first strip conductor 13A includes planar strips 14 and 15 and a conductor 16. In the present embodiment, as viewed along the z axis direction, the planar strip 14 has a rectangular shape whose lengths along the x axis direction and the y axis direction are approximately equal, and the planar strip 15 has a rectangular shape which is longitudinal along the x axis direction. The conductor 16 is located between the planar strip 14 and the planar strip 15, and is connected to the neighborhood of one end of the planar strip 15 along the longitudinal direction.

The first strip conductor 13A includes: a first end portion 13Aa at which signal power is supplied from the outside; and a second end portion 13Ab which is spaced apart from the first end portion 13Aa along the x direction. A distance d2 between the second end portion 13Ab and the radiating conductor 11 along the z axis direction is smaller than a distance d1 between the first end portion 13Aa and the radiating conductor 11 along the z axis direction (d2<d1). In other words, as the distance between the first strip conductor 13A and the radiating conductor 11 and the distance between the first strip conductor 13A and the ground conductor 12 vary along the longitudinal direction of the first strip conductor 13A, the gradient of an electromagnetic field within the dielectric space that is interposed between the radiating conductor 11 and the ground conductor 12 increases. The distance between the first strip conductor 13A and the ground conductor 12 may change in a stepwise manner between the first end portion 13Aa and the second end portion 13Ab. In this case, as viewed along the y axis direction, the first strip conductor 13A has one or more steps. Alternatively, the distance between the first strip conductor 13A and the ground conductor 12 may change in a gradual manner. In this case, the first strip conductor 13A may be inclined with respect to the radiating conductor 11 as viewed along the y axis direction. The first strip conductor 13A having such a structure makes it easier for a plurality of resonance modes to appear. As a result of this, the multiband antenna 51 is able to emit electromagnetic waves in a number of different frequencies, and yet it is easy to adjust the resonance frequency.

As viewed along the z axis direction, an end portion of the first strip conductor 13A overlaps the first slit 19A. More specifically, it is preferable that the center of the planar strip 14 of the first strip conductor 13A essentially coincides with the center along the x direction and y direction of the first slit 19A made in the radiating conductor 11. Specifically, the distance between the center of the planar strip 14 and the center along the x direction and y direction of the first slit 19A is preferably λ/8 or less, more preferably λ/10 or less, and still more preferably λ/20 or less, of the wavelength λ of the carrier wave.

At the first end portion 13Aa of the first strip conductor 13A, one end of the conductor 17 is connected. The conductor 17 is inserted in a hole 12c which is made in the ground conductor 12, so as to be led under the ground conductor 12. The other end of the conductor 17 is connected to a circuit pattern (not shown) that is formed below the ground conductor 12, for example.

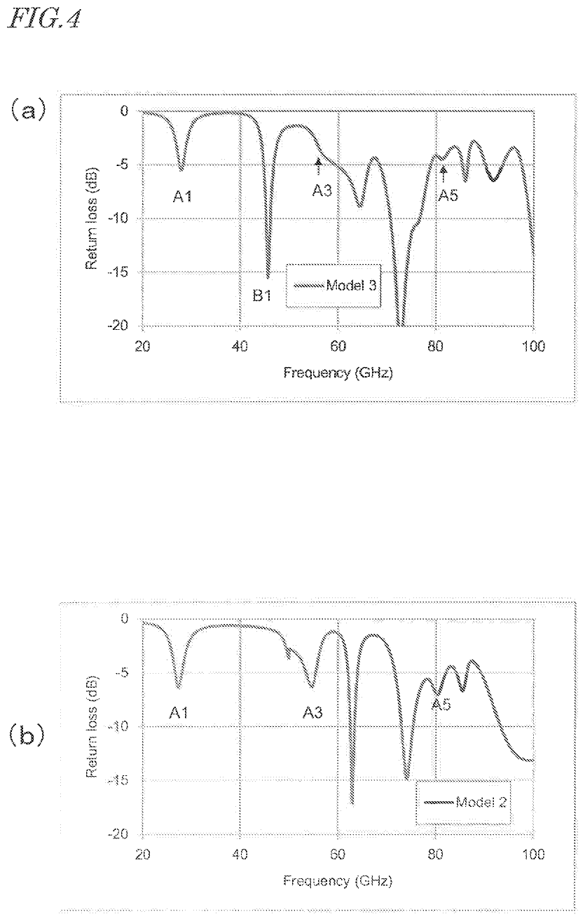

The size of the planar strip 15 of the first strip conductor 13A may be e.g. 0.1 to 2 mm×0.02 to 1 mm. Furthermore, its length along the x axis direction (resonance direction) is equal to or longer than that along the orthogonal direction (the y axis direction). On the other hand, the size of the planar strip 14 may be e.g. 0.02 to 1 mm×0.02 to 1 mm. Furthermore, on the basis of FIG. 3, in order to ensure that an electric field will adequately occur in a region of the first slit 19A spanning its transverse direction (the x axis direction) and the preceding and following regions (the +x direction or the −x direction), the dimension of the first slit 19A along the transverse direction is preferably set equal to or greater than the length of the planar strip 14 along the x axis direction. So long as an electric field is adequately supplied to the two aforementioned regions, the dimensions of the planar strip 14 may be small. In FIG. 1, for example, the planar strip 14 may be 0.225 mm (the x direction)×0.25 mm (the y direction), and the planar strip 15 may be 0.575 mm×0.125 mm.

The radiating conductor 11, the ground conductor 12, and the first strip conductor 13A are positioned in the dielectric 40. Since the radiating conductor 11 is an element to emit electromagnetic waves, from the standpoint of enhancing radiation efficiency, the radiating conductor 11 is preferably positioned on one principal face 40a of the dielectric 40. However, if the radiating conductor 11 is exposed on the principal face 40a, deformation may occur due to external forces or the like, or the radiating conductor 11 may undergo oxidation, corrosion, etc., through exposure to the external environment. According to a study by the inventors, it has been found that, so long as the thickness of the dielectric covering the radiating conductor 11 is 70 μm or less, a radiation efficiency can be achieved which is similar to or above that of the case where the radiating conductor 11 is formed on the principal face 40a and further an Au/Ni plating layer is formed thereon as a protective film.

The smaller the thickness t of a portion 40h of the dielectric 40 that covers the radiating conductor 11 is, the smaller the loss is; therefore, no lower limit exists from the standpoint of antenna characteristics. However, depending on the method of forming the dielectric 40, too small a thickness t may make it difficult to obtain a uniform thickness t. For example, in order to compose the dielectric of a multilayer ceramic body, the thickness t is preferably 5 μm or more, for example. In other words, more preferably, the thickness t is not less than 5 μm and not more than 70 μm. Especially, in order to employ as the dielectric 40 a low-relative permittivity ceramic with a relative permittivity of about 5 to 10 to achieve a radiation efficiency which is similar or superior to that of a planar antenna having Au/Ni plating, it is preferable that the thickness t is 5 μm or more, but less than 20 μm.

The dielectric 40 may be a resin, a glass, a ceramic, etc. having a relative permittivity of about 1.5 to 100. Preferably, the dielectric 40 is a multilayer dielectric in which a plurality of layers of resin, glass, ceramic, etc., are stacked. The dielectric 40 may be, for example, a multilayer ceramic body having a plurality of ceramic layers, with the radiating conductor 11, the ground conductor 12, and the planar strips 14 and 15 being provided among the plurality of ceramic layers, in which the conductors 16 and 17 are provided within one or more ceramic layers as via conductors. The intervals between these component elements along the z direction can be adjusted by varying the thickness and number of ceramic layers to be positioned in between component elements.

Each component element of the multiband antenna 51 is made of a material having electrical conductivity. For example, they may be made of materials containing a metal such as Au, Ag, Cu, Ni, Al, Mo, or W.

The multiband antenna 51 can be made by using a known technique, with the aforementioned dielectric materials and electrically conductive materials. In particular, it may be suitably produced by a multilayer (laminated) substrate technique using a resin, a glass, a ceramic, etc. For example, in the case where a multilayer ceramic body is used for the dielectric 40, co-fired ceramic substrate technology can be suitably used. In other words, the multiband antenna 51 can be produced as a co-fired ceramic substrate.

The co-fired ceramic substrate composing the multiband antenna 51 may be a low temperature co-fired ceramic (LTCC) substrate or a high temperature co-fired ceramic (HTCC) substrate. From a high-frequency characteristics standpoint, it may be preferable to use a low temperature co-fired ceramic substrate. For the dielectric 40, the radiating conductor 11, the ground conductor 12, and the planar strips 14 and 15, ceramic materials and electrically conductive materials may be used in accordance with the baking temperature, use, etc., as well as the frequency of wireless communications, etc. An electrically conductive paste for composing these elements and a green sheet for forming a multilayer ceramic body of the dielectric 40 are simultaneously baked (co-fired). In the case where the co-fired ceramic substrate is a low temperature co-fired ceramic substrate, a ceramic material and an electrically conductive material that permit sintering in a temperature range of about 800° C. to 1000° C. are used. The following may be used, for example: a ceramic material having main components of Al, Si, Sr and secondary components of Ti, Bi, Cu, Mn, Na, K; a ceramic material having main components of Al, Si, Sr and secondary components of Ca, Pb, Na, K; a ceramic material containing Al, Mg, Si, Gd; and a ceramic material containing Al, Si, Zr, Mg. Moreover, an electrically conductive material containing Ag or Cu can be used. The ceramic material has a dielectric constant of about 3 to 15. In the case where the co-fired ceramic substrate is a high temperature co-fired ceramic substrate, a ceramic material having a main component of Al and an electrically conductive material containing W (tungsten) or Mo (molybdenum) can be used.

More specifically, various materials can be used as an LTCC material, for example: an Al—Mg—Si—Gd—O-based dielectric material having a low dielectric constant (relative permittivity of 5 to 10); a dielectric material composed of a crystal phase of Mg₂SiO₄ and an Si—Ba—La—B—O-based glass, etc.; an Al—Si—Sr—O-based dielectric material; an Al—Si—Ba—O-based dielectric material; or a Bi—Ca—Nb—O-based dielectric material having a high dielectric constant (relative permittivity or 50 or more).

For example, in the case where the Al—Si—Sr—O-based dielectric material contains an oxide of Al, Si, Sr, Ti as main components, the Al—Si—Sr—O-based dielectric material preferably contains Al₂O₃: 10 to 60 mass %, SiO₂: 25 to 60 mass %, SrO: 7.5 to 50 mass %, and TiO₂: 20 mass % or less (including zero), where the main components Al, Si, Sr, and Ti are respectively translated into Al₂O₃, SiO₂, SrO, and TiO₂. Moreover, for 100 parts by mass of the main components, at least one selected from the group consisting of Bi, Na, K, and Co is preferably contained as a secondary component(s), namely: 0.1 to 10 parts by mass as translated into Bi₂O₃, 0.1 to 5 parts by mass as translated into Na₂O, 0.1 to 5 parts by mass as translated into K₂O, and 0.1 to 5 parts by mass as translated into CoO; and furthermore, at least one selected from the group consisting of Cu, Mn, and Ag is preferably contained, namely: 0.01 to 5 parts by mass as translated into CuO, 0.01 to 5 parts by mass as translated into Mn₃O₄, and 0.01 to 5 parts by mass of Ag. Inevitable impurities may also be contained.

Next, operation of the multiband antenna 51 will be described. When signal power is supplied from the conductor 17 to the first strip conductor 13A, the first strip conductor 13A establishes electromagnetic field coupling with the radiating conductor 11, and an electromagnetic wave that is based on the supplied signal power is emitted from the radiating conductor 11. This electromagnetic wave has an intensity distribution which has a maximum intensity in a direction that is perpendicular to the radiating conductor 11, i.e., the positive direction on the z axis, and which extends across the xz plane (which is parallel to the direction that the first strip conductor 13A extends). In the meantime, at the radiating conductor 11, as shown in FIG. 3, electromagnetic wave resonance may occur in two paths, namely: a path p1 from one end of the first strip conductor 13A that corresponds to the planar strip 14, around the first slit 19A, to a side 11c which is distant from the slit; and a path p2 connecting the one end of the first strip conductor 13A that corresponds to the planar strip 14 directly to the side 11c. Therefore, the multiband antenna 51 is capable of transmitting/receiving electromagnetic waves at two different frequencies f1 and f2. Herein, the frequency f2 is a frequency which is not a harmonic of frequency f1, such that f1<f2. When the position of the first slit 19A is changed along the x direction, the length of the path p2 has a greater variation with the position of the first slit 19A than does the variation of the length of the path p1. Therefore, by moving (changing) the position of the first slit 19 along the x axis direction, between the two frequencies f1 and f2 of the multiband antenna 51, it is possible to alter the frequency f2 while essentially fixing the frequency f1. The frequency f1 is essentially determined by the path p1, which in turn is determined by an interval L1 between the two sides 11c and 11d (located in the x axis direction) of the rectangle of the radiating conductor 11 and the position of the first slit 19A. The frequency f2 is essentially determined by the distance L2 between the center of the first slit 19A and the side 11c. When adjusting the position of the first slit 19, the center position of the planar strip 14 of the first strip conductor 13A is preferably moved so as to coincide with the center of the first slit 19.

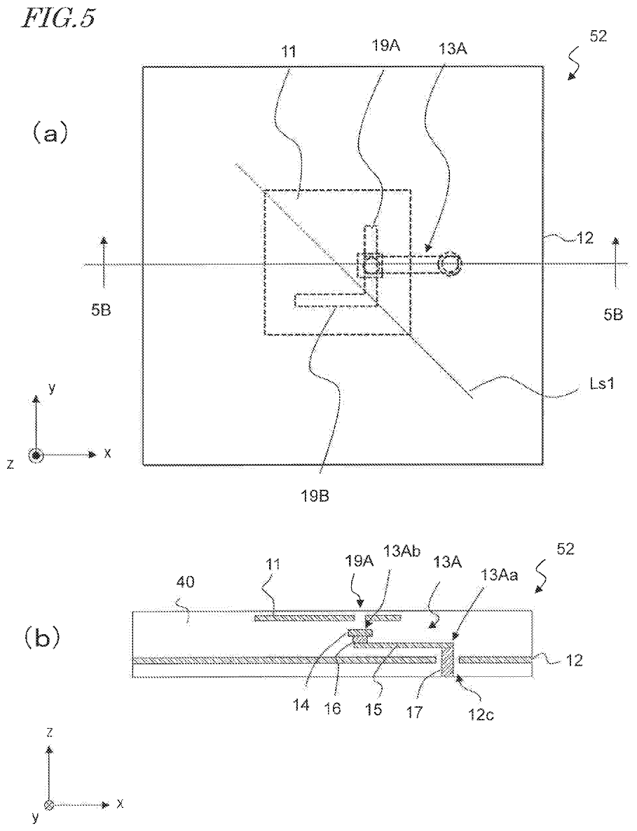

FIG. 4(a) shows an example of frequency characteristics of return loss of the multiband antenna 51 according to the present embodiment, as determined through a simulation. For comparison sake, frequency characteristics of return loss of an antenna whose radiating conductor lacks the first slit 19A is shown in FIG. 4(b). As shown in FIG. 4(b), in the antenna lacking the first slit 19A, a peak of the fundamental wave appears at about 27.3 GHz (Al), and harmonic peaks are observed at about 54.6 GHz (A3) and 80.5 GHz (A5).

Also, at about 64 GHz, a peak of resonance is observed that is determined by the shapes of the component elements of the first strip conductor 13A, the electromagnetic field coupling between the component elements of the first strip conductor 13A and the radiating conductor 11, and the like.

On the other hand, in the multiband antenna 51 according to the present embodiment, a new peak is created at 45.7 GHz (B1) on the lower frequency side of the aforementioned resonance peak, because of providing the first slit 19A. In the range from 20 to 50 GHz, there is no large peak (large return loss) other than the peaks Al and B1, which indicates that a multiband antenna is being realized that is capable of transmission/reception of electromagnetic waves at the frequencies of the peaks A1 and B1.

### Second Embodiment

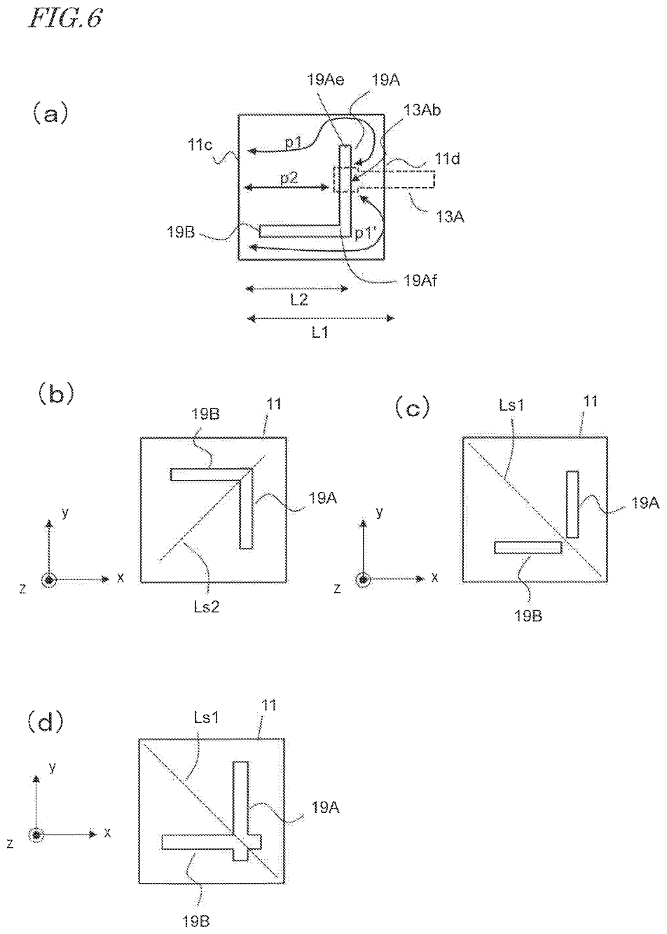

A second embodiment of a multiband antenna according to the present disclosure will be described. FIG. 5(a) is a schematic plan view of a multiband antenna 52, and FIG. 5(b) is a schematic cross-sectional view of the multiband antenna 52 along line 5B-5B in FIG. 5(a). The multiband antenna 52 differs from the multiband antenna 51 of the first embodiment in that the radiating conductor 11 further includes a second slit 19B.

The second slit 19B is a throughhole extending along the x axis direction, and may have a rectangular shape, for example. In the present embodiment, the second slit 19B connects to the first slit 19A. As used herein, connecting means that one end of one of the first slit 19A and the second slit 19B is connected to the other slit, and that the one end of the one slit does not extend beyond the other. In the present embodiment, one end of the second slit 19B is connected to one end of the first slit 19A. As a result, the first slit 19A and the second slit 19B constitute an L-shaped slit. As has been described in the first embodiment, an end portion of the first strip conductor 13A substantially coincides with the center along the x direction and y direction of the first slit 19A.

So long as the second slit 19B is shifted from the center of the first slit 19A along the y axis direction, the second slit 19B may be connected to the first slit 19A at any arbitrary position, on either the plus or minus side of the y axis direction. In the present embodiment, as described above, the second slit 19B is connected at one end of the first slit 19A, and, with respect to a line Ls1 which is inclined by −45° from the x axis, the first slit 19A and the second slit 19B are positioned axisymmetric to each other, as viewed along the z axis.

In the multiband antenna 52, when signal power is supplied from the first strip conductor 13A, at the radiating conductor 11, as shown in FIG. 6(a), different lengths exist between: an electromagnetic wave path p1 which begins from the second end portion 13Ab (corresponding to the planar strip 14 of the first strip conductor 13A), extends around an end portion 19Ae of the first slit 19A, and reaches the side 11c; and an electromagnetic wave path p1′ which begins from the second end portion 13Ab, extends around an end portion 19Af of the first slit 19A and the second slit 19B, and reaches the side 11c. In other words, the resonance frequency differs between an electromagnetic wave propagating through the path p1 and an electromagnetic wave propagating through the path p1′. As a result of this, between the two frequencies f1 and f2 of the multiband antenna 52 at which it is capable of transmission/reception, it is possible to expand the band of the lower frequency f1.

Without being limited to the above embodiment, positioning of the second slit 19B in the radiating conductor 11 admits of various modifications. For example, as shown in FIG. 6(b), the second slit 19B may be connected to one end of the first slit 19A on the plus side of the y axis direction, and, as viewed along the z axis, the first slit 19A and the second slit 19B may be positioned axisymmetric to each other with respect to a line Ls2 which is inclined by +45° from the x axis.

Moreover, as shown in FIG. 6(c), the second slit 19B may be spaced apart from the first slit 19A. In this case, the distance between the two slits is preferably λ/8 or less, more preferably λ/10 or less, and still more preferably λ/20 or less, of the wavelength λ of the carrier wave. In FIG. 6(c), the first slit 19A and the second slit 19B is positioned axisymmetric to each other with respect to the line Ls1, as viewed along the z axis.

Moreover, as shown in FIG. 6(d), the first slit 19A and the second slit 19B may cross each other. Crossing means that one slit intersects the other slit, and that the one slit extends beyond the other slit. The first slit 19A and the second slit 19B are positioned axisymmetric to each other with respect to the line Ls1, as viewed along the z axis.

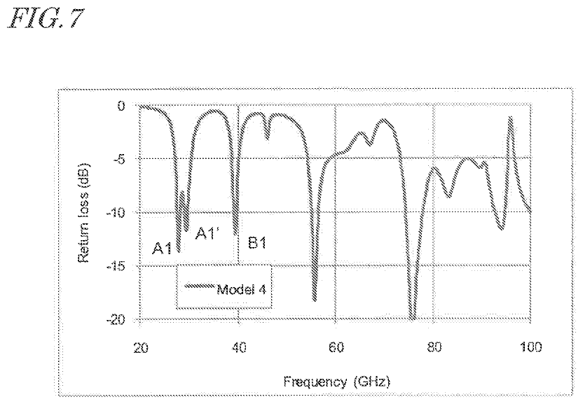

FIG. 7 shows an example of frequency characteristics of return loss of the multiband antenna 52 according to the present embodiment as determined through a simulation. A new peak A1′ has emerged at 29.3 GHz, which is near the 27.8 GHz peak A1. In the example shown in FIG. 7, the peak A1′ is distant by about 2 GHz from the peak A1; however, by adjusting the position and size of the second slit 19B, the interval between the peak A1 and the peak A1′ can be narrowed so that they can be mutually overlaid to become substantially one peak.

Thus, according to a multiband antenna of the present embodiment, between two frequencies at which transmission/reception are possible, one of them can have an expanded band.

### Third Embodiment

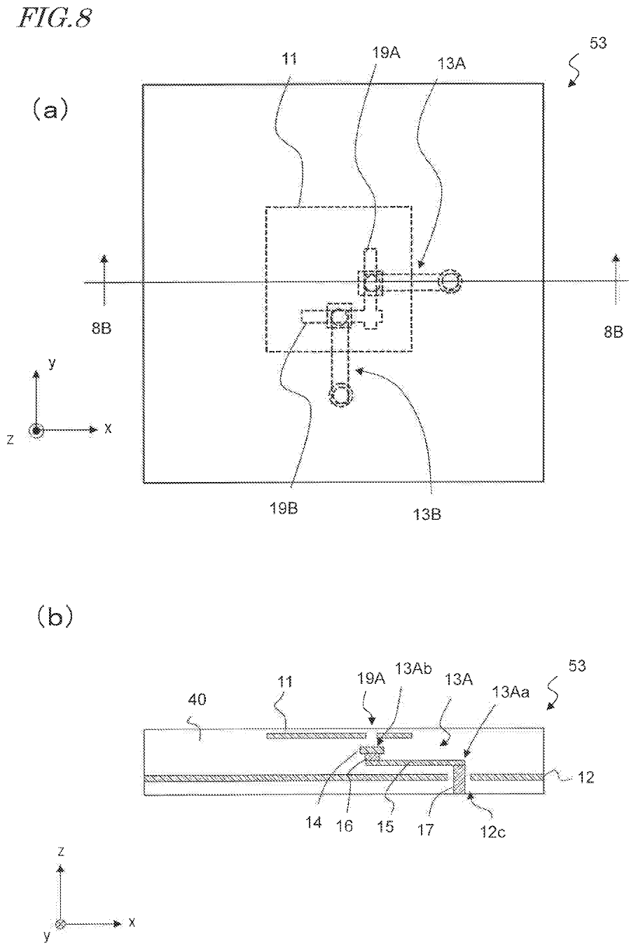

A third embodiment of a multiband antenna according to the present disclosure will be described. FIG. 8(a) is a schematic plan view of a multiband antenna 53, and FIG. 8(b) is a schematic cross-sectional view of the multiband antenna 53 along line 8B-8B in FIG. 8(a). The multiband antenna 53 differs from the multiband antenna 52 of the second embodiment in that it further includes a second strip conductor 13B.

Similarly to the first strip conductor 13A, the second strip conductor 13B is positioned between the radiating conductor 11 and the ground conductor 12. The second strip conductor 13B extends along the y axis direction, and overlaps the second slit 19B as viewed along the z axis direction. More specifically, one end of the second strip conductor 13B overlaps the second slit 19B so as to coincide with the center of the second slit 19B along the x direction and y direction. The second strip conductor 13B does not overlap the first slit 19A.

In the multiband antenna 53, signal power may be supplied to the first strip conductor 13A and the second strip conductor 13B. The first strip conductor 13A and the second strip conductor 13B may be used simultaneously, or either one of them may be used selectively.

When signal power is supplied to the first strip conductor 13A, the radiating conductor 11 emits an electromagnetic wave having an intensity distribution which has a maximum intensity in the positive direction on the z axis, and which extends across the xz plane (which is parallel to the direction that the first strip conductor 13A extends).

When signal power is supplied to the second strip conductor 13B, the radiating conductor 11 emits an electromagnetic wave having an intensity distribution which has a maximum intensity in the positive direction on the z axis, and which extends across the yz plane (which is parallel to the direction that the second strip conductor 13B extends). The direction of maximum intensity of this electromagnetic wave coincides with that of an electromagnetic wave occurring when the first strip conductor 13A is fed (the positive direction of the z axis), but its distribution is essentially orthogonal to the distribution of an electromagnetic wave occurring when the first strip conductor 13A is fed. Therefore, with the multiband antenna 53, it is possible to switch between two radiation characteristic profiles. Thus, it is possible to selectively perform transmission/reception of electromagnetic waves in a broader azimuth.

When the first strip conductor 13A and the second strip conductor 13B are simultaneously used, the multiband antenna 53 transmits/receives electromagnetic waves whose planes of polarization are orthogonal to each other. Since two electromagnetic waves whose planes of polarization are orthogonal to each other undergo little interference, and are capable of transmission/reception in a high quality state, the transmission speed of the multiband antenna 53 will be doubled, thus enabling high-speed and large-capacity communications.

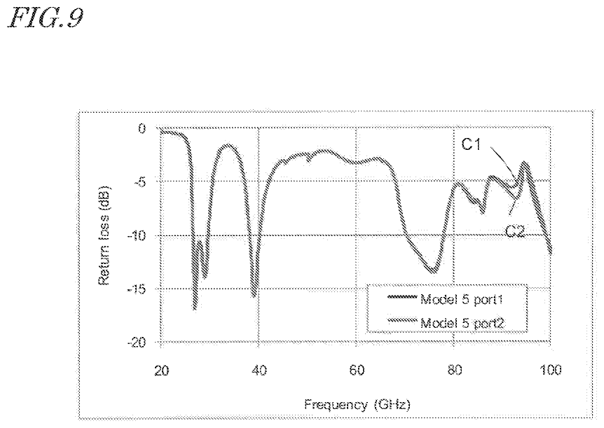

FIG. 9 shows an example of frequency characteristics of return loss of the multiband antenna 53 according to the present embodiment, as determined through a simulation. Curves C1 and C2 show frequency characteristic profiles which are obtained when the first strip conductor 13A and the second strip conductor 13B are fed, respectively. As shown in FIG. 9, the two frequency characteristic profiles match well, except for the neighborhood of 93 GHz. With the multiband antenna 53, it is possible to transmit/receive electromagnetic waves of different polarization directions.

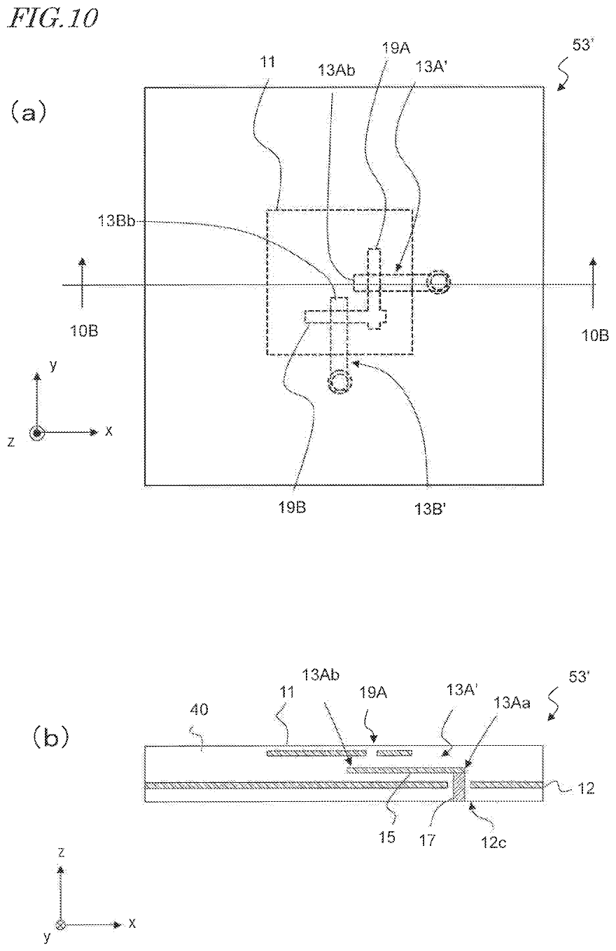

Note that, in the multiband antenna 53 of the present embodiment, the first strip conductor 13A and the second strip conductor 13B are inclined in the z axis direction. In other words, when viewed in a cross section as shown in FIG. 1(b), a line connecting the first end portion and the second end portion of the first strip conductor 13A and the second strip conductor 13B is inclined from the x axis direction. However, the multiband antenna may alternatively contain strip conductors that are not inclined in the z axis direction. As shown in FIGS. 10(a) and (b), a multiband antenna 53′ includes a first strip conductor 13A′ and a second strip conductor 13B′, such that the first strip conductor 13A′ and the second strip conductor 13B′ are each composed only of a planar strip 15.

In this case, as viewed along the z axis direction, the second end portion 13Ab of the first strip conductor 13A′ and the second end portion 13Bb of the second strip conductor 13B′ are preferably each located closer to the center of the radiating conductor 11 than are the first slit 19A and the second slit 19B. In the multiband antenna 53′, the frequency f1 changes depending on the length of the first strip conductor 13A′ along the x axis direction and the length of the second strip conductor 13B′ along the y axis direction.

### Fourth Embodiment

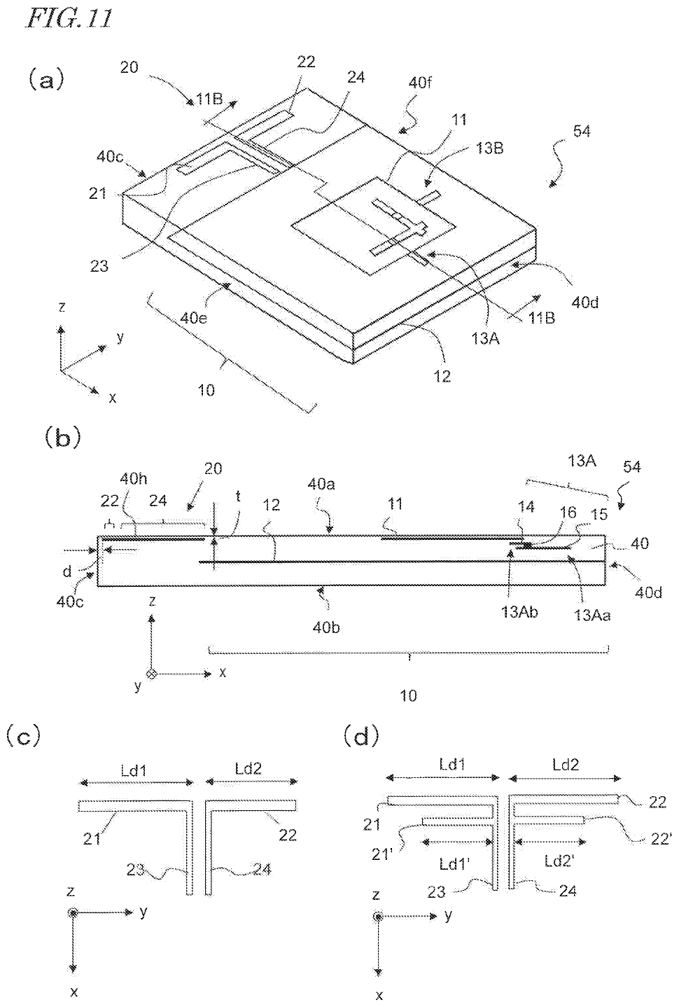

A fourth embodiment of a multiband antenna according to the present disclosure will be described. FIG. 11(a) is a schematic perspective view of a multiband antenna 54, and FIG. 11(b) is a schematic cross-sectional view of the multiband antenna 54 along line 11B-11B in FIG. 11(a). In FIG. 11(a), in order to depict the internal structure, the dielectric 40 is illustrated as if transparent.

The multiband antenna 54 includes a planar antenna 10 and a linear antenna 20. The planar antenna 10 may be any of the multiband antennas 51 to 53′ according to the first to third embodiments, having a similar structure to those of the multiband antennas 51 to 53′. In the implementation shown in FIG. 11, the planar antenna 10 is similar in structure to the multiband antenna 53. However, the planar antenna 10 differs from the multiband antenna 53 in that, in the present embodiment, the second slit 19B crosses the first slit 19A at a plus end portion of the y axis, and that the feeding position of the second strip conductor 13B is located on the plus side of the y axis.

The linear antenna 20 is spaced apart from the planar antenna 10 along the x axis direction. The linear antenna 20 includes at least one linear radiating conductor. In the present embodiment, the linear antenna 20 includes a linear radiating conductor 21 and a linear radiating conductor 22. The linear radiating conductor 21 and the linear radiating conductor 22 each have a stripe shape extending along the y direction, and are arranged close together along the y direction.

In order to supply signal power to the linear radiating conductor 21 and the linear radiating conductor 22, the linear antenna 20 further includes a powered conductor 23 and a powered conductor 24. The powered conductor 23 and the powered conductor 24 have a stripe shape extending along the x direction. One end of the powered conductor 23 and the powered conductor 24, respectively, is connected to one end of the linear radiating conductor 21 and the linear radiating conductor 22 thus arranged, where the one end of the linear radiating conductor 21 and the one end of the linear radiating conductor 22 lie adjacent to each other.

Depending on the use, the linear antenna 20 may be a single-band antenna, or a multiband antenna. In the case where the linear antenna 20 is used as a multiband antenna that is capable of transmission/reception at two or more frequencies, as shown in FIG. 11(c), lengths Ld1 and Ld2 of the linear radiating conductor 21 and the linear radiating conductor 22 along the y axis direction may be differed according to the used frequencies, for example. During transmission/reception of electromagnetic waves, one of the linear radiating conductor 21 and the linear radiating conductor 22 may be grounded, while the other may be connected to a transmission/reception circuit, whereby an electromagnetic wave of a frequency corresponding to the length Ld or Ld2 can be transmitted/received. By switching around the grounding and the connection to a transmission/reception circuit, it is possible to switch frequencies.

Moreover, a phase difference may be introduced between the linear radiating conductor 21 and the linear radiating conductor 22, and an electromagnetic wave may be transmitted/received by feeding or receiving signal power. In this case, as shown in FIG. 11(d), linear radiating conductors 21 and 21′ may be connected to the powered conductor 23, for example, thus introducing differing lengths Ld1 ands Ld1′ of the linear radiating conductors 21 and 21′ along the y axis direction. Similarly, linear radiating conductors 22 and 22′ may be connected to the powered conductor 24, thus introducing differing lengths Ld2 and Ld2′ of the linear radiating conductors 22 and 22′ along the y axis direction. As a result of this, it is possible to transmit/receive electromagnetic waves of different frequencies by using the linear radiating conductor 21, 21′ and linear radiating conductor 22, 22′ that have the lengths corresponding to electromagnetic waves for transmission/reception, among the linear radiating conductors 21 and 21′ and linear radiating conductors 22 and 22′ thus connected.

As viewed along the z axis direction, the linear radiating conductor 21 and the linear radiating conductor 22 of the linear antenna 20 may or may not overlap the ground conductor 12. As viewed along the z axis direction, when the linear radiating conductors 21 and 22 of the linear antenna 20 do not overlap the ground conductor 12, it is preferable that the linear radiating conductors 21 and 22 of the linear antenna 20 are distant from the edge of the ground conductor 12 by λ/8 or more along the x axis direction. As viewed along the z axis direction, when the linear radiating conductors 21 and 22 of the linear antenna 20 overlap the ground conductor 12, it is preferable that the ground conductor 12 and the linear radiating conductors 21 and 22 are distant by λ/8 or more along the z axis direction.

A portion of the linear antenna 20 that contains the other ends of the powered conductor 23 and the powered conductor 24 may overlap the ground conductor 12 as viewed along the z axis direction. One of the other ends of the powered conductor 23 and the powered conductor 24 is connected to a reference potential, while signal power is supplied to the other. Alternatively, signal power may be supplied to both of the other end of the powered conductor 23 and the other end of the powered conductor 24. The length of the linear radiating conductor 21 and the linear radiating conductor 22 along the y direction may be e.g. about 1.2 mm. Their length (width) along the x direction may be e.g. about 0.2 mm. The other ends of the powered conductor 23 and the powered conductor 24 are connected to a circuit or the like that is constructed below the ground conductor 12, by using conductors similar to the conductor 17 (e.g., a via conductor).

Next, positioning of the linear antenna 20 in the dielectric 40 will be described. The dielectric 40 may have the shape of a rectangular solid that includes a principal face 40a, a principal face 40b, and side faces 40c, 40d, 40e and 40f, for example. The principal face 40a and the principal face 40b are the two faces that are larger than the other faces, among the six faces of the rectangular solid. The principal face 40a and the principal face 40b are parallel to the radiating conductor 11 and the ground conductor 12. The linear radiating conductors 21 and 22 are positioned on the principal face 40a of the dielectric 40 or inside the dielectric 40. The linear radiating conductors 21 and 22 may be positioned at the same height as the radiating conductor 11 along the z axis direction, for example. The thickness t of the portion 40h of the dielectric 40 that covers the linear radiating conductors 21 and 22 is preferably 5 μm or more, but less than 20 μm, for the reason described in the first embodiment. Preferably, the linear radiating conductors 21 and 22 are adjacent to the principal face 40a, and located close to the side face 40c or 40d that is perpendicular to the x axis. The reason is that, since the linear antenna 20 emits an electromagnetic wave in the −x axis direction, the thickness of the dielectric 40 covering the linear radiating conductors 21 and 22 along the x axis direction is preferably small. The distance d from the side face 40c to the linear radiating conductor 21, 22 along the x axis direction is preferably 70 μm or less, and more preferably not less than 5 μm and not more than 70 μm.

Similarly to the planar antenna 10, each component element of the linear antenna 20 is composed of a material having electrical conductivity.

In the multiband antenna 54, when signal power is supplied to the first strip conductor 13A or the second strip conductor 13B, the planar antenna 10 emits an electromagnetic wave having an intensity distribution which has a maximum intensity in the positive direction on the z axis and which has a different plane of polarization. On the other hand, when signal power is supplied to the linear antenna 20, the linear antenna 20 emits an electromagnetic wave having an intensity distribution which has a maximum intensity in the negative direction on the x axis.

With the multiband antenna 54, by using the planar antenna 10 and the linear antenna 20 to perform transmission/reception of electromagnetic waves and selectively using the antenna that provides a received signal with the greater intensity, or by performing transmission/reception with a base station or the like and using the antenna that is capable of transmitting good electromagnetic waves, satisfactory communications can be performed. Moreover, when using the planar antenna 10, similarly, the first strip conductor 13A and the second strip conductor 13B may be used to perform transmission/reception; intensity of the received signal or stability of communications with a base station or the like may be evaluated; and the strip conductor that provides the better state of communication may be used to perform transmission/reception.

### Fifth Embodiment

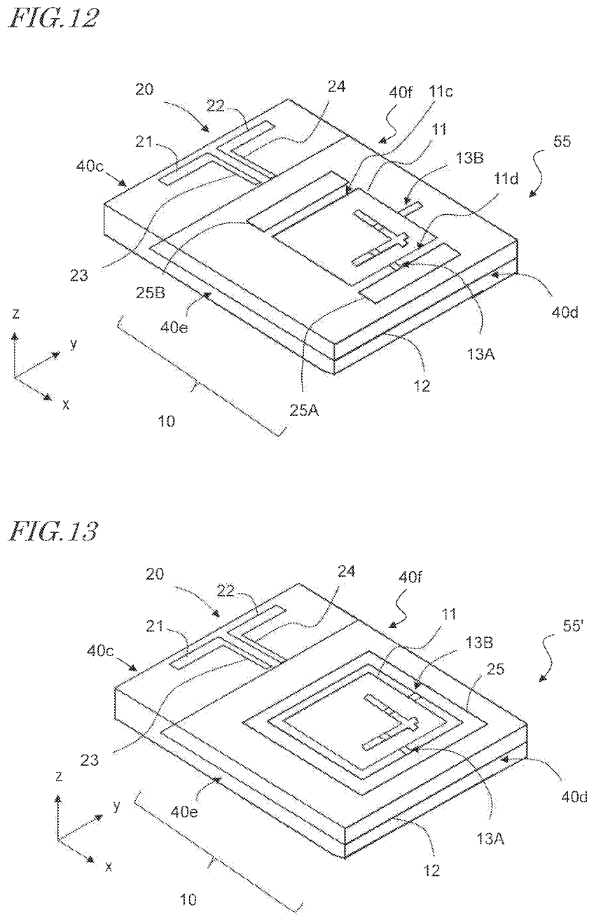

A fifth embodiment of a multiband antenna according to the present disclosure will be described. FIG. 12 is a schematic perspective view of a multiband antenna 55. The multiband antenna 55 differs from the multiband antenna 54 of the fourth embodiment in that the planar antenna 10 further includes at least one unpowered radiating conductor.

In the present embodiment, the planar antenna 10 of the multiband antenna 55 further includes at least one unpowered radiating conductor that is positioned adjacent to at least one of a pair of sides 11c and 11d of the radiating conductor 11 located in the x axis direction. More specifically, the planar antenna 10 further includes unpowered radiating conductors 25A and 25B which are positioned adjacent to the sides 11c and 11d, respectively.

The unpowered radiating conductors 25A and 25B do not have power supplied from the first strip conductor 13A and the second strip conductor 13B. Moreover, they are spaced apart from the radiating conductor 11. The unpowered radiating conductors 25A and 25B may be positioned at the same height as the radiating conductor 11 along the z axis direction, for example.

In the multiband antenna 55, because of including the unpowered radiating conductors 25A and 25B, the planar antenna 10 is able to emit electromagnetic waves with high gain in a broader angle. This effect is particularly enhanced especially when signal power is supplied to the first strip conductor 13A to radiate an electromagnetic wave.

Rather than in the x direction, the unpowered radiating conductor(s) may be positioned in the y direction from the radiating conductor 11. Moreover, the unpowered radiating conductor(s) may be positioned in both the x direction and the y direction from the radiating conductor 11. For example, as shown in FIG. 13, a multiband antenna 55′ includes an unpowered radiating conductor 25 surrounding the radiating conductor 11. The unpowered radiating conductor 25 has a rectangular ring shape, whose inner edge is spaced apart from the outer edge of the radiating conductor 11 by a predetermined interval. In the multiband antenna 55′, the planar antenna 10 includes the unpowered radiating conductor 25 being adjacent to the radiating conductor 11 in the x direction and the y direction therefrom. As a result, when emitting an electromagnetic wave having an intensity distribution which has a maximum intensity in the positive direction on the z axis and which extends across the xz plane (which is parallel to the direction that the first strip conductor 13A extends), and an electromagnetic wave having an intensity distribution which has a maximum intensity in the positive direction on the z axis and which extends across the yz plane (which is parallel to the direction that the second strip conductor 13B extends), it is possible to emit electromagnetic waves with high gain in a broader angle.

### Sixth Embodiment

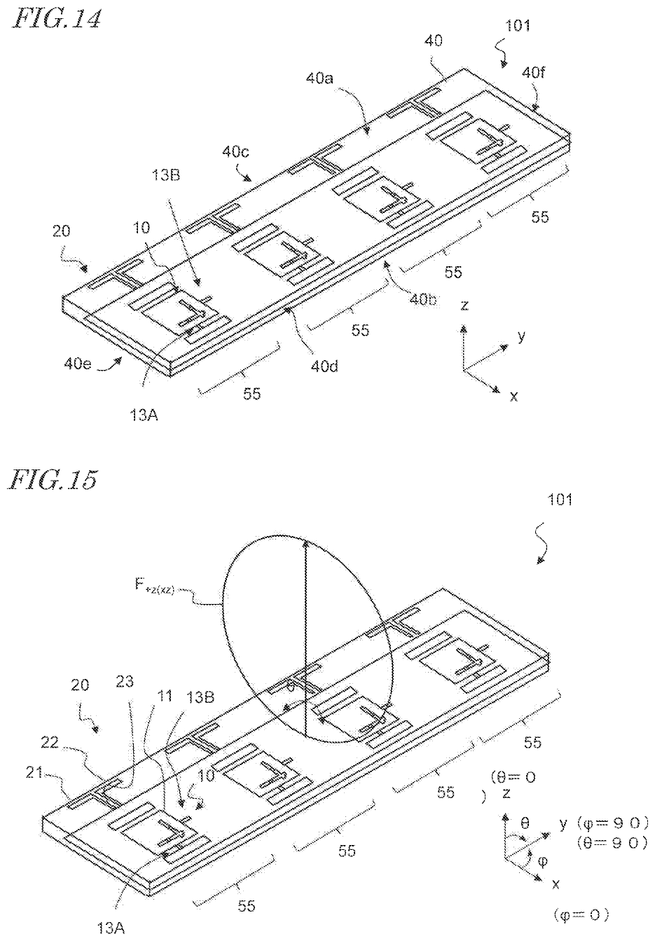

An embodiment of an array antenna according to the present disclosure will be described. FIG. 14 is a schematic perspective view of an array antenna 101. The array antenna 101 includes a plurality of any of the multiband antennas 51 to 55 of the first to fifth embodiments. For example, the array antenna 101 may include a plurality of multiband antennas 55. Although the array antenna 101 includes four multiband antennas 55 in the present embodiment, the number of multiband antennas 55 is not limited to four; the array antenna 101 may include at least two multiband antennas 55.

In the array antenna 101, the plurality of multiband antennas 55 are arranged along the y direction. In other words, they are positioned so that the radiating conductors 11 of the multiband antennas 55 are adjacent to one another along the y direction, and that the linear antennas 20 are adjacent to one another along the y direction. The ground conductors 12 of the multiband antenna 55 are connected to one another, such that they constitute one electrically conductive layer as a whole. The dielectrics 40 of the multiband antennas 55 are also connected to one another, so as to constitute a single dielectric as a whole. The array pitch of the plurality of multiband antennas 55 along the y direction is about λ/2.

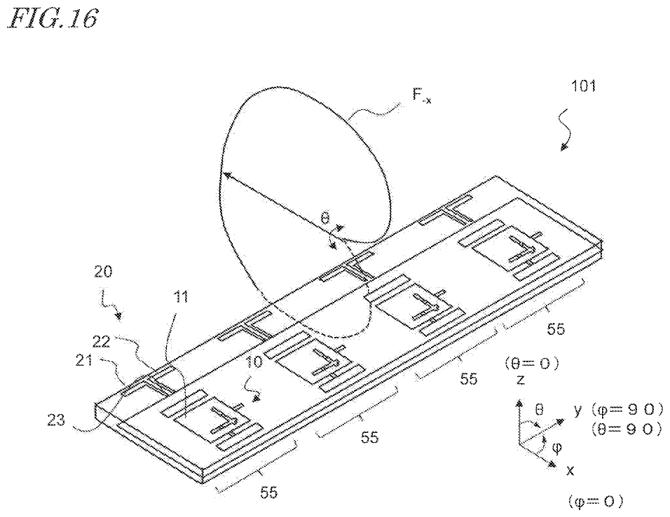

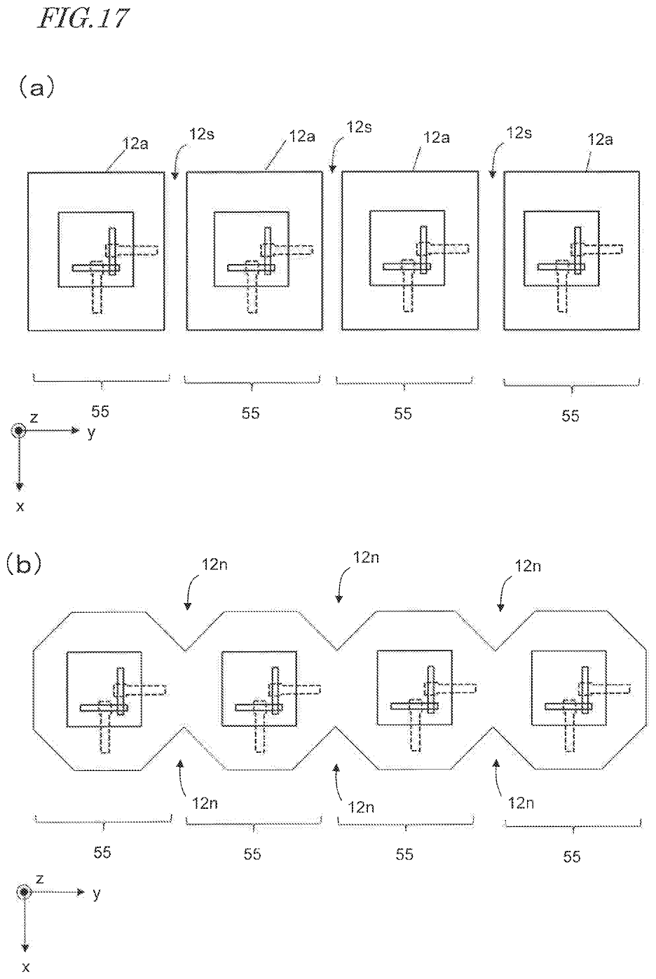

With reference to FIG. 15 and FIG. 16, operation of the array antenna 101 will be described. In the array antenna 101, when signal power is fed to the planar antenna 10 of each multiband antenna 55 via the first strip conductor 13A, as shown in FIG. 15, the radiating conductors 11 of the multiband antennas 55, as a whole, transmit/receive an electromagnetic wave having a maximum intensity in a direction that is perpendicular to the radiating conductor 11, i.e., the positive direction on the z axis, having a directivity F_{+z(xz)} which extends across the xz plane (which is parallel to the direction that the first strip conductor 13A extends), and having a plane of polarization parallel to the ZX plane. On the other hand, when signal power is fed to the planar antenna 10 of each multiband antenna 55 via the second strip conductor 13B, the radiating conductors 11 of the multiband antennas 55, as a whole, transmit/receive an electromagnetic wave having a maximum intensity in a direction that is perpendicular to the radiating conductor 11, i.e., the positive direction on the z axis, and having a plane of polarization parallel to the YZ plane. On the other hand, as shown in FIG. 16, when signal power is supplied to the linear antenna 20 of each multiband antenna 55, the linear radiating conductors 21 and 22, as a whole, emit an electromagnetic wave having an intensity distribution which has a maximum intensity in the negative direction on the x axis, and having a directivity F₋ₓ which extends across the xz plane.

In the array antenna 101, the planar antennas 10 and the linear antennas 20 may be used either simultaneously or selectively. In each planar antenna 10, signal power may be simultaneously supplied to the first strip conductor 13A and the second strip conductor 13B. By feeding these antennas simultaneously, when a decrease in gain due to interference is undesirable, e.g., when supplying in-phase signal power to the planar antenna 10 and the linear antenna 20, an RF switch or may be used to input a signal for transmission/reception selectively to the planar antenna 10 or the linear antenna 20.

When simultaneously using the planar antenna 10 and the linear antenna 20, it is preferable to introduce a phase difference between the signals to be input to the planar antenna 10 and the linear antenna 20. This can reduce interference, and improve gain. For example, by using a phase shifter or the like that is composed of diode switches, MEMS switches, etc., the signals for transmission/reception may be selectively input to the planar antenna 10 or the linear antenna 20.

The array antenna 101 includes the plurality of multiband antennas 55. As a result, by selecting one of the planar antenna 10 and the linear antenna 20 in each multiband antenna 55, and feeding it with in-phase signal power, a more enhanced directivity can be provided than is possible with an intensity distribution that is based on a single multiband antenna 55. Moreover, by appropriately shifting the phase of signal power to be fed to the planar antenna 10 or the linear antenna 20 of each multiband antenna 55 so as to introduce phase differences between the planar antennas 10 or linear antennas 20 of the respective multiband antennas 55, or introducing a phase difference between the planar antenna 10 and the linear antenna 20 of each multiband antenna 55 and further causing this phase difference to differ between multiband antennas 55 as necessary, the direction of maximum intensity can be changed in a θ direction in the xz plane (φ=0°) and in a θ direction within the yz plane (p=90°). Thus, by providing the plurality of multiband antennas 55 in an array configuration, the direction of high directivity can be changed in the xz plane and in the yz plane. For example, during transmission/reception, phase differences may be introduced between the planar antennas 10 or linear antennas 20 of the respective multiband antennas 55 in carrying out transmission/reception of electromagnetic waves, and, the direction (θ, φ) which provides the highest reception intensity or in which best transmission/reception of electromagnetic waves with a base station or the like can be attained may be determined at predetermined time intervals while carrying out transmission/reception of the electromagnetic waves. As a result, when a wireless communication device having the array antenna 101 mounted thereon moves, for example, transmission/reception of electromagnetic waves can be performed in an optimum state of communication at all times.

Thus, with the array antenna 101 according to the present disclosure, it is possible to radiate electromagnetic waves in two orthogonal directions, and to receive electromagnetic waves from two orthogonal directions.

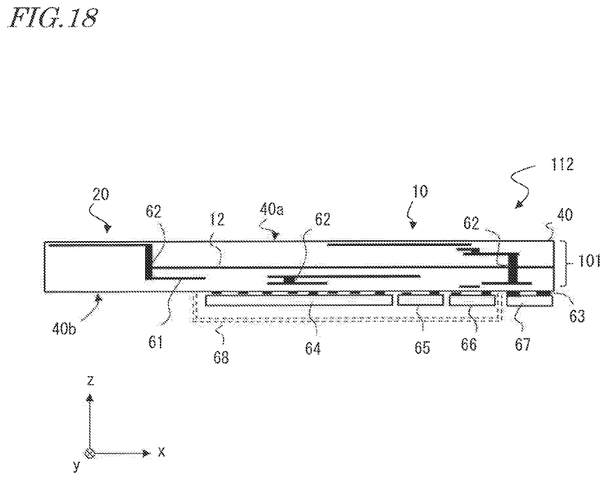

In the array antenna 101, since the ground conductor 12 is continuous along the y direction, when the second strip conductors 13B are fed to radiate electromagnetic waves, there may be cases where the output power of electromagnetic waves may decrease due to the influence of reflection of electromagnetic waves which propagate in the ground conductor 12 along the y direction. When such a decrease in output power is undesirable, as shown in FIG. 17(a), slits 12s may be provided in the ground conductor 12 between adjacent multiband antennas 55, thus electrically isolating the ground conductors 12a of the respective multiband antennas 55.

Moreover, in each multiband antenna 55 of the array antenna 101, when signal power is simultaneously supplied to the first strip conductor 13A and the second strip conductor 13B of the planar antenna 10, since the ground conductor 12 is continuous along the y direction, the expanse of electromagnetic waves based on the two strip conductors may be affected by the shape of the ground conductor 12, such that the combined electromagnetic wave may become spread along the y direction. When the shape of distribution of the combined electromagnetic wave is an issue, as shown in FIG. 17(b), recesses 12n may be provided in the ground conductor 12 between adjacent multiband antennas 55. Each recess 12n may be an isosceles right triangle whose base is a side that is perpendicular the x axis direction, for example. By providing the recesses 12n, the difference in shape between the x direction and the y direction of the ground conductor 12 of each multiband antenna 55 can be mitigated, so that the combined electromagnetic wave can have an increased symmetry around the z axis.

Although the recesses are based on the shape of the conductors, a similar effect can also be obtained by providing cavities or the like. Other than a technique of providing slits, recesses, or cavities, a technique of introducing differences in electric resistance, a technique of introducing differences in dielectric constant, or the like may be employed. At least one technique among these may be employed.

### Seventh Embodiment

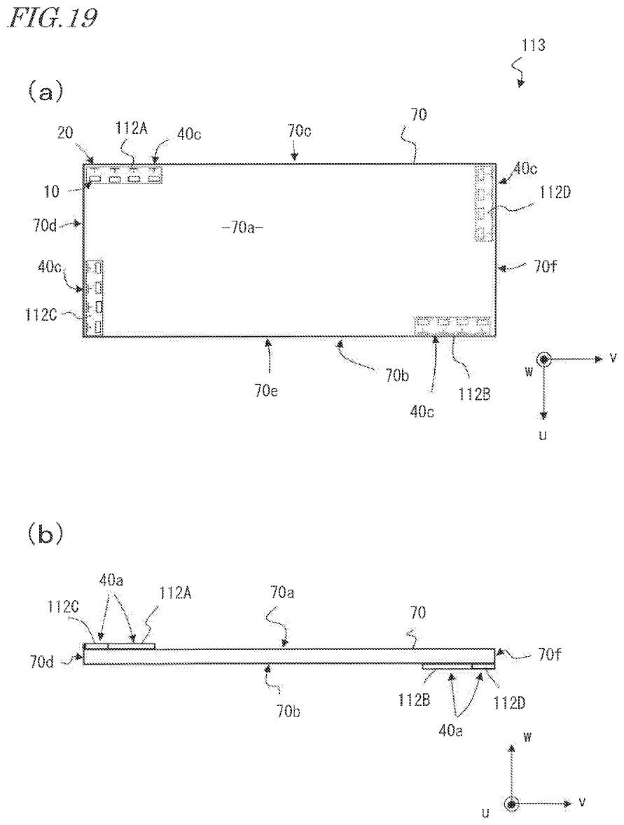

An embodiment of a wireless communication module according to the present disclosure will be described. FIG. 18 is a schematic cross-sectional view of a wireless communication module 112. The wireless communication module 112 includes: the array antenna 101 according to the sixth embodiment; active elements 64 and 65; a passive element 66; and electrodes 63 and a connector 67 connected thereto. The wireless communication module 112 may further include a cover 68 that covers the active elements 64 and 65 and the passive element 66. The cover 68 may be made of a metal or the like, and serve as an electromagnetic shield or a heat sink, or have both functions.

On the side of the dielectric 40 of the array antenna 101 that is closer to the principal face 40b with respect to the ground conductor 12, conductors 61 and via conductors 62 constituting a wiring circuit pattern are provided, for connection with the planar antennas 10 and linear antennas 20. The planar antennas 10, the linear antennas 20, and the conductors 61 are connected through the via conductors 62. The principal face 40b has the electrodes 63 provided thereon.

The active elements 64 and 65 are DC/DC converters, low-noise amplifiers (LNA), power amplifiers (PA), high-frequency ICs, etc., whereas the passive element 66 is a capacitor, a coil, an RF switch, or the like. The connector 67 is a connector for connecting the wireless communication module 112 to the outside at an intermediate frequency.

The active elements 64 and 65, the passive element 66, and the connector 67 are connected to the electrodes 63 on the principal face 40b of the dielectric 40 of the array antenna 101 via solder or the like, thus being mounted on the principal face 40b of the array antenna 101. A signal processing circuit or the like is composed of the wiring circuit constituted by the conductors 61 and the via conductors 62, the active elements 64 and 65, the passive element 66, and the connector 67.

In the wireless communication module 112, the principal face 40a, to which the planar antenna 10 and the linear antenna 20 are located close, is located on the opposite side to the principal face 40b, to which the active elements 64 and 65 and the like are connected. Therefore, without being affected by the active elements 64 and 65 and the like, electromagnetic waves of a quasi-millimeter wave/millimeter wave band can be radiated from the planar antennas 10 and the linear antennas 20, and radio waves of quasi-millimeter wave and millimeter wave bands arriving from the outside can be received at the planar antennas 10 and the linear antennas 20. Therefore, a small-sized wireless communication module can be realized which includes antennas that are capable of selectively transmitting/receiving electromagnetic waves in two orthogonal directions.

### Eighth Embodiment

An embodiment of a wireless communication apparatus according to the present disclosure will be described. FIGS. 19(a) and (b) are a schematic plan view and a side view of a wireless communication apparatus 1B. The wireless communication apparatus 113 includes a main board 70 and one or more wireless communication modules 112. In FIG. 19, the wireless communication apparatus 113 includes four wireless communication modules 112A through 112D.

The main board 70 includes electronic circuitry necessary for realizing the functions of the wireless communication apparatus 113, a wireless communication circuit, and the like. In order to detect the attitude and position of the main board 70, it may include a geomagnetic sensor, a GPS unit, etc.

The main board 70 has principal faces 70a and 70b and four lateral sides 70c, 70d, 70e and 70f. The principal faces 70a and 70b are perpendicular to the w axis of the second right-hand orthogonal coordinate system; the lateral sides 70c and 70e are perpendicular to the u axis; and the lateral sides 70d and 70f are perpendicular to the v axis. Although FIG. 19 schematically illustrates the main board 70 as a rectangular solid having a rectangular principal face, each of the lateral sides 70c, 70d, 70e and 70f may consist of a plurality of faces.

In the wireless communication apparatus 113, the wireless communication modules 112A through 112D are each positioned on the principal face 70a or the principal face 70b in such a manner that the side face 40c of the dielectric 40 of the array antenna 101 is located close to one of the lateral sides 70c, 70d, 70e and 70f, and that the principal face 40a of the dielectric 40 is located on an opposite side to the main board 70. The side face 40c of the dielectric 40 has the linear radiating conductors 21 and 22 of the linear antenna 20 located close thereto, such that an electromagnetic wave is radiated from the side face 40c. Moreover, the principal face 40a of the dielectric 40 has the radiating conductor 11 of the planar antenna 10 located close thereto, such that an electromagnetic wave is radiated from the principal face 40a. Therefore, the wireless communication modules 112A through 112D are positioned on the main board 70 in such positions and directions that electromagnetic waves radiated from the wireless communication modules 112A through 112D are unlikely to interfere with the main board 70. The wireless communication modules 112A through 112D may be located close together, or apart, along each of the uvw directions.

For instance, in the example shown in FIG. 19, the wireless communication modules 112A and 112C are positioned on the principal face 70a so that the side faces 40c of the wireless communication modules 112A and 112C are located close to either the lateral side 70c or 70d. On the other hand, the wireless communication modules 112B and 112D are positioned on the principal face 70b so that the side faces 40c of the wireless communication modules 112B and 112D are located close to either the lateral side 70e or 70f. In the present embodiment, the side face 40c of the wireless communication module 112A is located close to the lateral side 70c, whereas the side face 40c of the wireless communication module 112B is located close to the lateral side 70e. On the other hand, the side face 40c of the wireless communication module 112C is located close to the lateral side 70d, whereas the side face 40c of the quasi-millimeter wave/millimeter wave wireless communication module 112D is located close to the lateral side 70f. The wireless communication modules 112A through 112D are positioned in point symmetric manners with respect to the center of the main board 70.

In the distributions of electromagnetic waves to be radiated from the planar antenna 10 and the linear antenna 20 of the wireless communication modules 112A through 112D thus positioned, the directions of maximum intensity are as shown in Table 1.

TABLE 1

| quasi-millimeter | | |
|---|---|---|
| wave/miilimeter wave | | |
| wireless communication | radiating direction of | radiating direction of |
| module | planar antenna 10 | linear antenna 20 |
| 112A | +w | −u |
| 112B | −w | +u |
| 112C | +w | −v |
| 112D | −w | +v |

Thus, electromagnetic waves can be radiated in all azimuths (±u, ±v, ±w directions) with respect to the main board 70. For example, by using a GPS unit in the wireless communication apparatus 113 to perform position detection, among a plurality of base stations which are around the wireless communication apparatus 113 and of which position information is known, it is possible to determine: the base station that is the closest; and the azimuth of that base station from the wireless communication apparatus 113. Moreover, by using a geomagnetic sensor in the wireless communication apparatus 113, the attitude of the wireless communication apparatus 113 can be determined, whereby it is possible to determine which one of the wireless communication modules 112A through 112D and the planar antenna 10/linear antenna 20 can radiate with the strongest intensity an electromagnetic wave toward the determined base station to communicate with, given the current attitude of the wireless communication apparatus 113. Thus, by performing transmission/reception of electromagnetic waves with the determined wireless communication module and antenna, it is possible to perform high-quality communications.

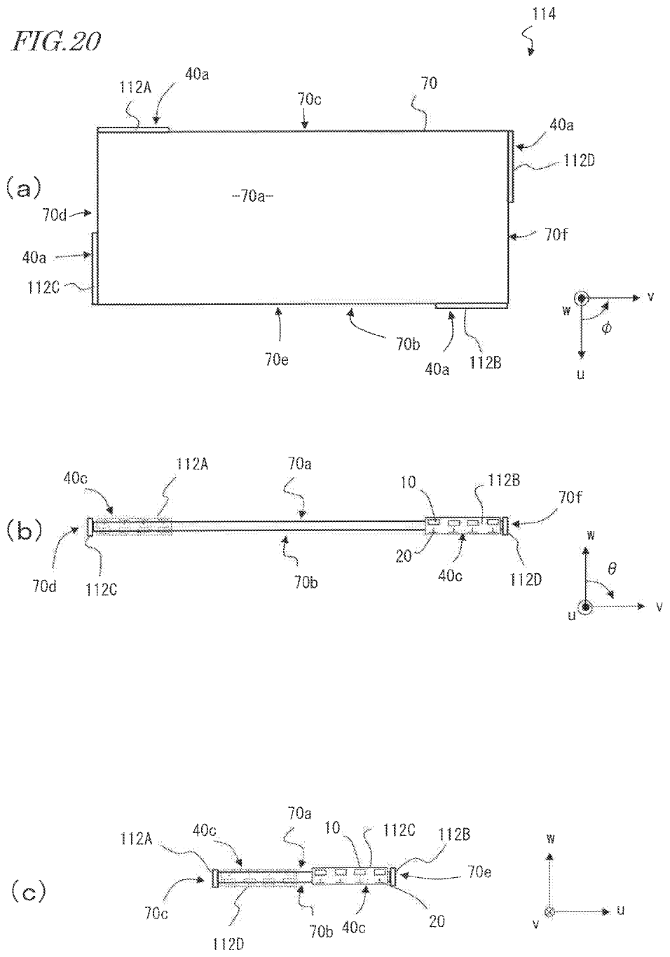

The wireless communication modules 112A through 112D may be positioned on a lateral side of the main board 70. FIGS. 20(a), (b) and (c) are a schematic plan view and lateral side views of the wireless communication apparatus 114. In the wireless communication apparatus 114, the wireless communication modules 112A through 112D are each positioned on one of the lateral sides 70c through 70f in such a manner that the side face 40c of the dielectric 40 of the array antenna 101 is located close to the principal face 70a or the principal face 70b, and that the principal face 40a of the dielectric 40 is located on an opposite side to the main board 70.

In the example shown in FIG. 20, the wireless communication modules 112A and 112B are positioned on the lateral sides 70c and 70e so that the side faces 40c of the wireless communication modules 112A and 112B are located close to either the principal face 70a or 70b. On the other hand, the wireless communication modules 112C and 112D are positioned on the lateral sides 70d and 70f so that the side faces 40c of the wireless communication modules 112C and 112D are located close to either the principal face 70a or 70b. In the present embodiment, the side face 40c of the wireless communication module 112A is located close to the principal face 70a, whereas the side face 40c of the wireless communication module 112B is located close to the principal face 70b. On the other hand, the side face 40c of the wireless communication module 112C is located close to the principal face 70a, whereas the side face 40c of the wireless communication module 112D is located close to the principal face 70b. The wireless communication modules 112A through 112D are positioned in point symmetric manners with respect to the center of the main board 70. The positions of the wireless communication modules 112A through 112D along the w axis direction may be shifted from the center of the main board 70 along the w axis direction. Moreover, the wireless communication modules 112A through 112D may be in contact with, or positioned at an interval from, the lateral sides 70c through 70f of the main board 70.

In the distributions of electromagnetic waves to be radiated from the planar antenna 10 and the linear antenna 20 of the wireless communication modules 112A through 112D thus positioned, the directions of maximum intensity are as shown in Table 2.

TABLE 2

| wireless communication | radiating direction of | radiating direction of |
|---|---|---|
| module | planar antenna 10 | linear antenna 20 |
| 112A | −u | +w |
| 112B | +u | −w |
| 112C | −v | +w |
| 112D | +v | −w |

Thus, with the positioning shown in FIG. 20, too, the wireless communication apparatus 114 allows electromagnetic waves to be radiated in all azimuths (±u, ±v, ±w directions) with respect to the main board 70.

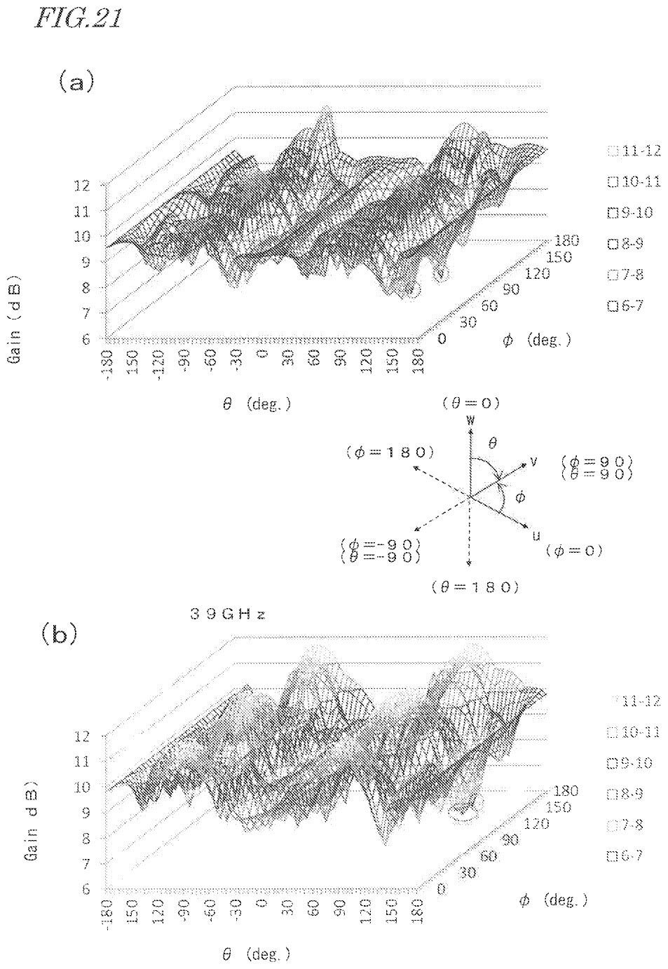

FIGS. 21(a) and (b) show exemplary results of a simulation for determining the intensity distribution of electromagnetic waves to be radiated from the wireless communication apparatus 114 in which four wireless communication modules are positioned as shown in FIG. 20. FIG. 21(a) shows a distribution of 28 GHz electromagnetic waves, whereas FIG. 21(b) shows a distribution of 39 GHz electromagnetic waves. The θ indicating the direction of an electromagnetic wave, as shown in FIG. 20(a), represents an angle in the WV plane from the w axis, which reads plus toward the v axis direction from the w axis. The φ represents an angle in the uv plane from the u axis, which reads plus toward the v axis direction from the u axis. Although the gain magnitude varies depending on the angles θ and φ, a gain of 7 dB or above is attained in most regions of θ and φ. In FIGS. 21(a) and (b), regions with a gain less than 7 dB are surrounded by broken lines. In 28 GHz electromagnetic waves, within all ranges of θ and φ, a gain of 7 dB or more is attained in a range of about 99.8%. In 39 GHz electromagnetic waves, within all ranges of θ and φ, a gain of 7 dB or more is attained in a range of about 99.7%. Thus, in accordance with the present embodiment, by positioning the wireless communication modules 112A through 112D in different azimuths, and selectively driving the linear antenna or the planar antenna, a wireless communication apparatus having a high azimuth coverage and good directivity can be realized.

### Other Embodiments

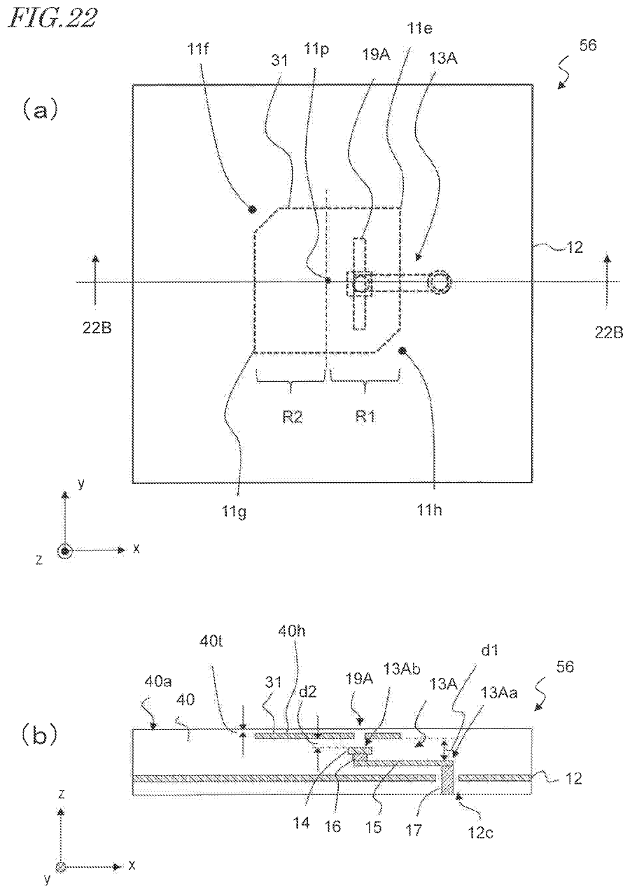

A multiband antenna, an array antenna, a wireless communication module, and a wireless communication apparatus according to the present disclosure are applicable to transmission/reception of electromagnetic waves of circular polarization. However, in order to more efficiently transmit/receive waves of circular polarization, the structure of the multiband antenna may be modified. FIGS. 22(a) and (b) are: a plan view of a multiband antenna 56, in which the multiband antenna 51 of the first embodiment is adapted to right-handed circular polarization; and a cross-sectional view along line 22B-22B in (a). The multiband antenna 56 differs from the multiband antenna 51 in that a pair of corners located along a diagonal direction of the radiating conductor 11 are truncated.

Specifically, the multiband antenna 56 includes a radiating conductor 31. The radiating conductor 31 has a shape obtained by linearly truncating a pair of corners located along a diagonal direction, from a rectangle having four corners 11e through 11h. In the implementation shown in FIG. 22, on the plane of the radiating conductor 31, when the corners 11e through 11h are viewed from the center of the radiating conductor 31, the corner 11h that is located on the right side of the first strip conductor 13A and the corner 11f that is located diagonally from the corner 11h are truncated along a line that is substantially parallel to a line passing through the corners 11e and 11g. As a result, the multiband antenna 56 is able to efficiently transmit/receive waves of right-handed circular polarization. In the following, too, the right side or the left side of a strip conductor is based on the relative positioning of the strip conductor when the corners 11e through 11h are viewed from the center of the radiating conductor.

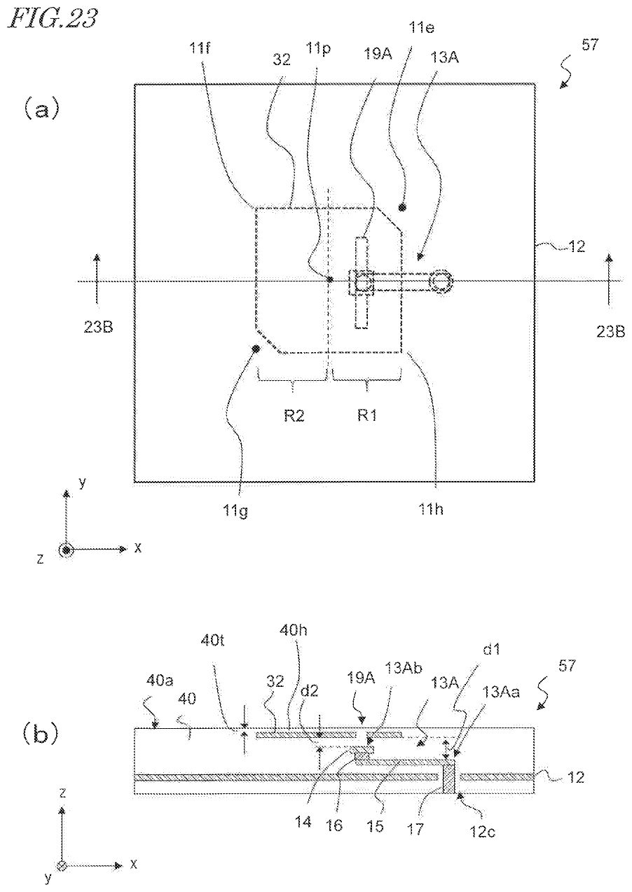

FIGS. 23(a) and (b) are: a plan view of a multiband antenna 57, in which the multiband antenna 51 of the first embodiment is adapted to left-handed circular polarization; and a cross-sectional view along line 23B-23B in (a). The radiating conductor 32 of the multiband antenna 57 has a shape obtained by linearly truncating the corners 11e and 11g located along a diagonal direction, from a rectangle having four corners 11e through 11f, for example. The corner 11e is located on the left side of the first strip conductor 13A, and the corner 11g is located diagonally from the corner 11e. As a result, the multiband antenna 57 is able to efficiently transmit/receive waves of left-handed circular polarization.

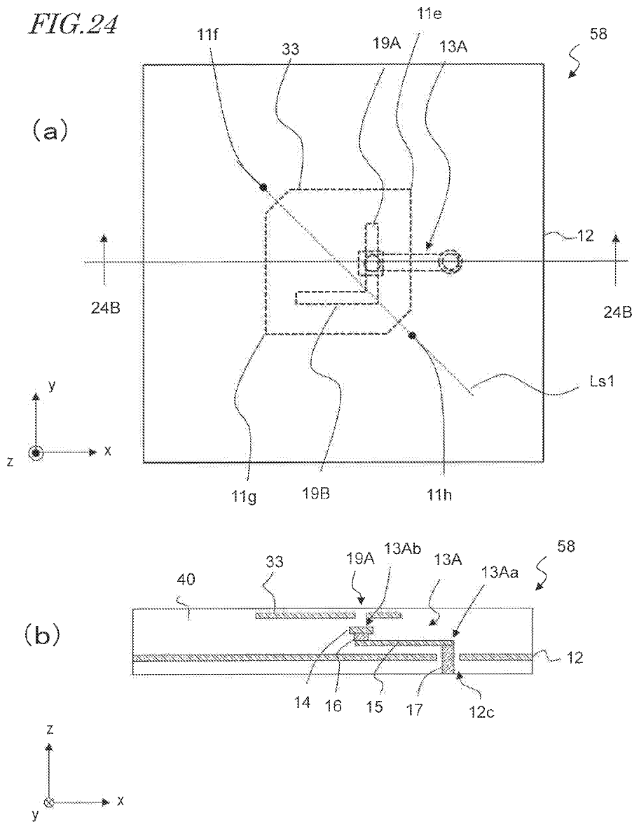

FIGS. 24(a) and (b) are: a plan view of a multiband antenna 58, in which the multiband antenna 52 of the second embodiment is adapted to right-handed circular polarization; and a cross-sectional view along line 24B-24B in (a). The multiband antenna 58 differs from the multiband antenna 52 in that a pair of corners located along a diagonal direction of the radiating conductor 11 are truncated.

Specifically, the multiband antenna 58 includes a radiating conductor 33. The radiating conductor 33 has a shape obtained by linearly truncating a pair of corners located along a diagonal direction, from a rectangle having four corners 11e through 11h. In the implementation shown in FIG. 24, the corner 11h that is located on the right side of the first strip conductor 13A and the corner 11f that is located diagonally from the corner 11h are truncated along a line that is substantially parallel to a line passing through the corners 11e and 11g. As a result, the multiband antenna 58 is able to efficiently transmit/receive waves of right-handed circular polarization.

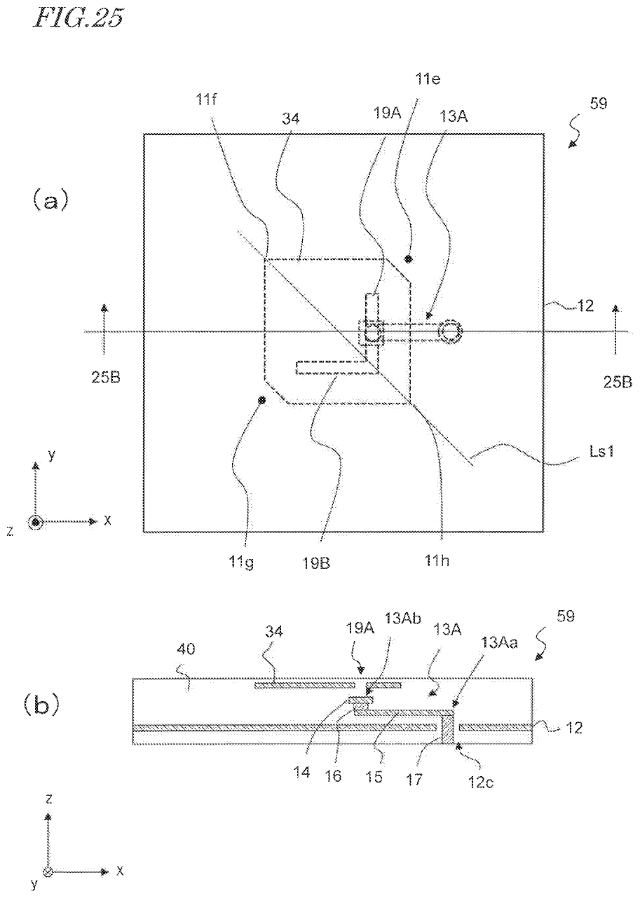

FIGS. 25(a) and (b) are: a plan view of a multiband antenna 59, in which the multiband antenna 52 of the second embodiment is adapted to left-handed circular polarization; and a cross-sectional view along line 25B-25B in (a). The radiating conductor 34 of the multiband antenna 59 has a shape obtained by linearly truncating the corners 11e and 11g located along a diagonal direction, from a rectangle having four corners 11e through 11h, for example. The corner 11e is located on the left side of the first strip conductor 13A, and the corner 11g is located diagonally from the corner 11e. As a result, the multiband antenna 59 is able to efficiently transmit/receive waves of left-handed circular polarization.

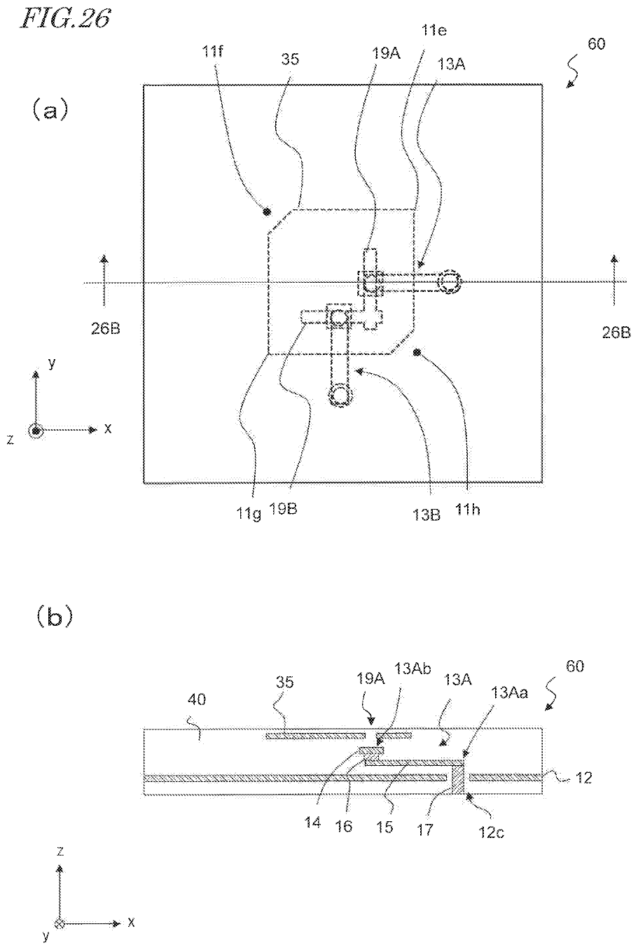

FIGS. 26(a) and (b) are: a plan view of a multiband antenna 60, in which the multiband antenna 53 of the second embodiment is adapted to circular polarization; and a cross-sectional view along line 26B-26B in (a). The radiating conductor 35 of the multiband antenna 60 has a shape obtained by linearly truncating the corners 11f and 11h located along a diagonal direction, from a rectangle having four corners 11e through 11h. In plan view, the corner 11h is located between the first strip conductor 13A and the second strip conductor 13B.

In the multiband antenna 60, when using the first strip conductor 13A, it is possible to transmit/receive waves of right-handed circular polarization, and when using the second strip conductor 13B, it is possible to transmit/receive waves of left-handed circular polarization. Moreover, as described above, when signal power is simultaneously supplied to the first strip conductor 13A and the second strip conductor 13B, it is possible to simultaneously transmit waves of right-handed circular polarization and left-handed circular polarization, or separate and/or detect electromagnetic waves containing waves of right-handed circular polarization and waves of left-handed circular polarization by using the first strip conductor 13A and the second strip conductor 13B.

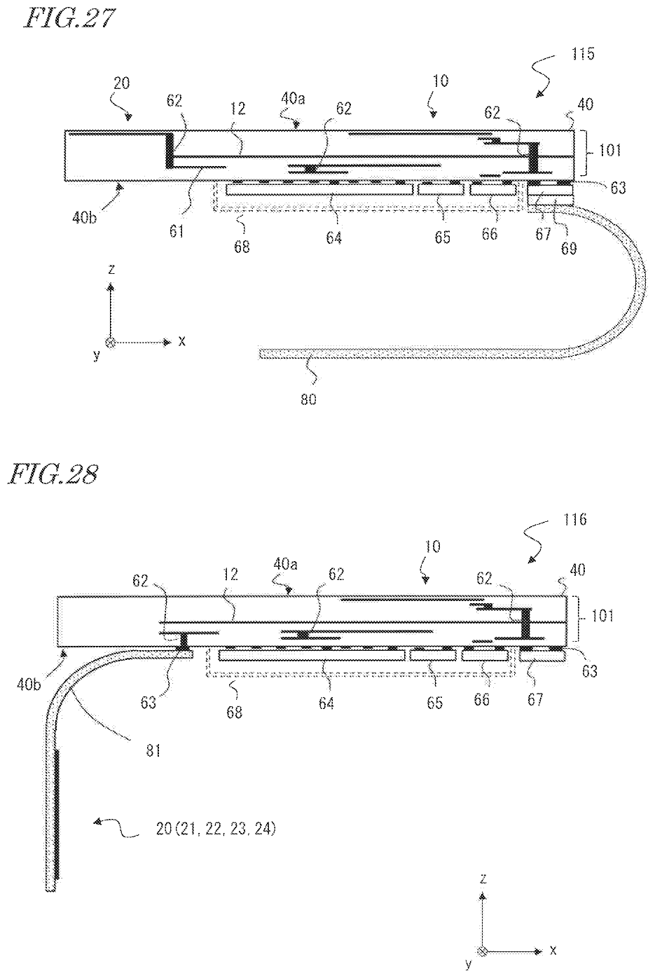

Moreover, the wireless communication module 112 of the seventh embodiment can be suitably combined with flexible wiring. A wireless communication module 115 shown in FIG. 27 differs from the wireless communication module 112 in that it includes flexible wiring 80. The flexible wiring 80 may be a flexible printed wiring board having a wiring circuit formed thereon, a coaxial cable, a liquid crystal polymer substrate, or the like, for example. In particular, a liquid crystal polymer excels in high-frequency characteristics, and therefore can be suitably used as a wiring circuit for the array antenna 101. The flexible wiring 80 includes a connector 69, the connector 69 being engaged with the connector 67 which is provided on the principal face 40b.

Moreover, in the case where a plurality of wireless communication modules are to be included, for example, wireless modules each including the linear antenna 20 and the multiband antenna 55 may be connected by way of a circuit that involves the flexible wiring 80 shown in FIG. 27.

Moreover, a part of the radiating conductors included in the wireless communication module 112 may be positioned on the flexible wiring. In the wireless communication module 116 shown in FIG. 28, some of the plurality of electrodes 63 provided on the principal face 40b are electrically connected to the flexible wiring 81. On the surface and/or the inside of the flexible wiring 81, for example, a part or a whole of the linear radiating conductors 21 and 22, the powered conductors 23 and 24, etc., of the array antenna 101 are provided.

In accordance with the wireless communication module 116, by bending the flexible wiring 81, the linear radiating conductors 21 and 22 provided on the flexible wiring 81 can be positioned in different directions from the linear radiating conductors 21 and 22 provided on the dielectric 40. Therefore, it is possible to transmit or receive electromagnetic waves in a broader azimuth. Although all of the linear antennas 20 are positioned on the flexible wiring 81 in the implementation shown in FIG. 28, at least one of the plurality of linear antennas 20 composing the array antenna 101 may be formed on the flexible wiring 81.

### INDUSTRIAL APPLICABILITY

A multiband antenna, an array antenna, a wireless communication module, and a wireless communication apparatus according to the present disclosure can be suitably used in antennas for various high-frequency wireless communications and a wireless communication circuit including such antennas, and are particularly suitably used in wireless communication apparatuses of the quasi-microwave, centimeter wave, quasi-millimeter wave, and millimeter wave bands.

### REFERENCE SIGNS LIST

10: planar antenna
11, 31 to 35: radiating conductor
11c, d: side
11e through 11h: corner
11p: center
12: ground conductor
12c: hole
12n: recess
12s: slit
13: strip conductor
13A: first strip conductor
13Aa: first end portion
13Ab: second end portion
13B: second strip conductor
13Bb: second end portion
14, 15: planar strip
16: conductor
17: conductor
19A: first slit
19Ae, 19Af: end portion
19B: second slit
20: linear antenna
21, 21′, 22, 22′: linear radiating conductor
23, 24: powered conductor
25, 25A, 25B: unpowered radiating conductor
40: dielectric
40a, 40b: principal face
40c through 40f: side face
40h: dielectric portion with thickness t
51, 52, 53, 53′, 54, 55, 55′, 56 to 60: multiband antenna
61: conductor
62: via conductor
63: electrode
64, 65: active element
66: passive element
67, 69: connector
68: cover
70: main board
70a, 70b: principal face
70c through 70f: lateral side
80, 81: flexible wiring
101: array antenna
112, 115, 116: wireless communication module
113, 114: wireless communication apparatus

1. A multiband antenna comprising:
a radiating conductor including a rectangular-shaped first slit extending along a second axis direction of a first right-hand orthogonal coordinate system having a first axis direction, the second axis direction, and a third axis direction;
a ground conductor which is spaced apart from the radiating conductor by a predetermined interval along the third axis direction; and
a first strip conductor being positioned between the radiating conductor and the ground conductor, and extending along the first axis direction, wherein
an end portion of the first strip conductor overlaps the first slit, when viewed along the third axis direction.

2. The multiband antenna of claim 1, wherein an end portion of the first strip conductor overlaps a neighborhood of a center of the first slit when viewed along the third axis direction.

3. The multiband antenna of claim 1, wherein,
the radiating conductor includes a first region and a second region which are separated by a border line extending along the second axis direction at a center of the first axis direction; and
when viewed along the third axis direction, the first strip conductor overlaps the first region of the radiating conductor but does not overlap the second region.

4. The multiband antenna of claim 1, wherein the radiating conductor further includes a rectangular-shaped second slit extending along the first axis direction.

5. The multiband antenna of claim 4, wherein, in the radiating conductor, the second slit is spaced apart from the first slit.

6. The multiband antenna of claim 4, wherein, in the radiating conductor, the second slit crosses or connects to the first slit.

7. The multiband antenna of claim 4, wherein, in the radiating conductor, the first slit and the second slit are positioned axisymmetric to each other with respect to a line which passes through an origin of the first right-hand orthogonal coordinate system and which makes an angle of 45° with the first axis when viewed along the third axis direction.

8. The multiband antenna of claim 4, further comprising a second strip conductor being positioned between the radiating conductor and the ground conductor and extending along the second axis direction; and
when viewed along the third axis direction, an end portion of the second strip conductor overlaps the second slit but does not overlap the first slit.

9. The multiband antenna of claim 1, wherein opposite ends of the first strip conductor are located at different heights along the third axis direction.

10. The multiband antenna of claim 1, further comprising at least one unpowered radiating conductor positioned adjacent to at least one of a pair of sides of the radiating conductor, the pair of sides being located in the first axis direction or in the second axis direction.

11. The multiband antenna of claim 1, further comprising an unpowered radiating conductor which surrounds the radiating conductor and which is spaced apart the radiating conductor when viewed along the third axis direction.

12. The multiband antenna claim 1, further comprising one or more linear radiating conductors being spaced apart from the radiating conductor along the first axis direction and extending along the second axis direction, wherein,
the radiating conductor, the first strip conductor, and the ground conductor constitute a planar antenna; and
the linear radiating conductor constitutes a linear antenna.

13. The multiband antenna of claim 12, wherein the linear radiating conductor does not overlap the ground conductor when viewed along the third axis direction.

14. The multiband antenna of claim 1, further comprising a dielectric having a principal face perpendicular to the third axis direction, wherein at least the ground conductor and the first strip conductor are located within the dielectric.

15. The multiband antenna of claim 12, further comprising a dielectric having a principal face perpendicular to the third axis direction and a side face which is adjacent to the principal face and which is perpendicular to the first axis direction, wherein,
at least the ground conductor and the first strip conductor are located within the dielectric; and
the linear radiating conductor of the linear antenna is located close to the side face.

16-17. (canceled)

18. The multiband antenna of claim 1, wherein the radiating conductor has a shape obtained by truncating a pair of corners of a rectangle having four corners, the pair of corners being located along a diagonal direction.

19. A multiband array antenna comprising a plurality of multiband antennas of claim 1, wherein,
the plurality of multiband antennas are arranged along the second axis direction; and
the ground conductors of the plurality of multiband antennas are connected together along the second axis direction.

20. A wireless communication module comprising the multiband array antenna of claim 19.

21. A wireless communication apparatus comprising:
a circuit board including, based on a second right-hand orthogonal coordinate system having a first axis direction, a second axis direction, and a third axis direction: a first principal face and a second principal face perpendicular to the third axis direction; a first side face and a second side face perpendicular to the first axis direction; and a third side face and a fourth side face perpendicular to the second axis direction, the circuit board including at least one of a transmission circuit and a reception circuit; and
at least one wireless communication module of claim 20, wherein,
the wireless communication module is positioned on any of the first side face, the second side face, the third side face, and the fourth side face.

22. A wireless communication apparatus comprising:
a circuit board including, based on a second right-hand orthogonal coordinate system having a first axis direction, a second axis direction, and a third axis direction: a first principal face and a second principal face perpendicular to the third axis direction; a first side face and a second side face perpendicular to the first axis direction; and a third side face and a fourth side face perpendicular to the second axis direction, the circuit board including at least one of a transmission circuit and a reception circuit; and
at least one wireless communication module of claim 20, wherein,
the wireless communication module is positioned in any of: a portion of the first principal face near the first side face; a portion of the first principal face near the third side face; a portion of the second principal face near the third side face; and a portion of the second principal face near the fourth side face.
